(19) United States
(12) Patent Application Publication
(10) Pub. No.: US 2026/0257503 A1
(43) Pub. Date: Sep. 3, 2026

(54) IMAGE FORMING APPARATUS

(71) Applicant: FUJIFILM CORPORATION, Minato-ku, Tokyo (JP)

(72) Inventor: Hayate NAKAMURA, Kanagawa (JP)

(21) Appl. No.: 19/671,265

(22) Filed: May 8, 2026

Related U.S. Application Data
(63) Continuation of application No. PCT/JP2024/038008, filed on Oct. 24, 2024.

(30) Foreign Application Priority Data
Nov. 21, 2023 (JP) 2023-197533

(51) Int. Cl. B41J 13/00; B41J 3/60; B41J 11/00

(52) U.S. Cl. CPC B41J 13/0018; B41J 3/60; B41J 11/002; B41J 13/0045

(57) ABSTRACT

An image forming apparatus includes a transport mechanism including a transport passage that transports a recording medium; an image forming unit that forms an image on the recording medium; a drying unit that is capable of performing pre-drying of drying the recording medium before image formation; and a processor that controls the transport mechanism, the image forming unit, and the drying unit, in which the processor is configured to switch between a first mode in which the pre-drying is performed and a second mode in which the pre-drying is not performed.

### CROSS-REFERENCE TO RELATED APPLICATIONS

This application is a continuation of International Application No. PCT/JP2024/038008, filed on October 24, 2024, which claims priority from Japanese Patent Application No. 2023-197533, filed on November 21, 2023. The entire disclosure of each of the above applications is incorporated herein by reference.

### BACKGROUND

### 1. Technical Field

The present disclosure relates to an image forming apparatus.

### 2. Related Art

Some image forming apparatuses, such as an electrophotographic printing apparatus using a toner and an inkjet printing apparatus using an ink, include a drying unit for drying an image formed on a recording surface of a recording medium (for example, refer to JP3597487B). In a case where the recording surface is brought into contact with a transport mechanism or the like in a state where the image formed on the recording surface is insufficiently dried, fine white spots may be generated in the image due to ink bleeding or the like in a state where the drying is insufficient. The drying unit is used for the purpose of suppressing the occurrence of a quality defect such as the fine white spots by performing post-drying of the formed image before the recording surface is brought into contact with the transport mechanism or the like after the image is formed.

As a measure for further suppressing the occurrence of such a quality defect, there is a method of performing pre-drying of the recording medium before image recording in addition to the post-drying. In the pre-drying, the moisture of the recording medium is reduced, so that the drying is suppressed from being insufficient due to the energy from the drying unit being taken away by the evaporation of the moisture of the recording medium during the post-drying. As a result, the effect of the post-drying can be further enhanced, and the occurrence of the quality defect such as the fine white spots may be further suppressed.

The image forming apparatus described in JP3597487B uses an electrophotographic image forming unit and an inkjet image forming unit in combination, and includes a fixing unit that fixes an image formed by the electrophotographic method to the recording medium by heat as the drying unit. Further, JP3597487B discloses that the radiant heat of the fixing unit may be used for post-drying of an image formed by the inkjet method, pre-drying before image formation, and the like.

### SUMMARY

As described above, a method of performing pre-drying for suppressing the quality defect is known, but the present inventors have found through intensive studies that there is a case where it is better not to perform the pre-drying depending on the type of the recording medium. For example, depending on the recording medium, the recording medium may be excessively dried by the pre-drying, and the recording medium may be deformed, which may cause a quality defect.

The present disclosure has been made in view of the above circumstances, and an object of the present disclosure is to provide an image forming apparatus capable of suppressing a quality defect in image formation.

An image forming apparatus comprising: a transport mechanism including a transport passage that transports a recording medium;

an image forming unit that forms an image on the recording medium;

a drying unit that is capable of performing pre-drying of drying the recording medium before image formation; and

a processor that controls the transport mechanism, the image forming unit, and the drying unit,

in which the processor is configured to switch between a first mode in which the pre-drying is performed and a second mode in which the pre-drying is not performed.

The drying unit may be capable of performing, in addition to the pre-drying, post-drying of drying the image formed on the recording medium after the image is formed in the image forming unit.

The processor may be configured to switch a passage for transporting the recording medium by controlling the transport mechanism, and switch between the first mode and the second mode by switching the passage.

In the image forming apparatus, it is preferable that image formation is sequentially performed on a plurality of the recording media by continuously supplying the plurality of recording media to the transport passage, and the drying unit performs both the pre-drying and the post-drying on each of the plurality of recording media.

In the image forming apparatus, among the plurality of recording media continuously passing through a section in which the drying unit is disposed in the transport passage, the drying unit may perform the pre-drying on an N-th recording medium and performs the post-drying on an (N+1)-th recording medium.

The image forming apparatus may comprise two printing modes including a single-sided printing mode in which an image is formed on only one surface of the recording medium and a duplex printing mode in which an image is formed on both a first surface and a second surface of the recording medium.

In this case, it is preferable that, in the image forming apparatus, at least a part of the transport passage is shared in the single-sided printing mode and the duplex printing mode.

In the image forming apparatus, in a case where image formation is sequentially performed on a plurality of the recording media by continuously supplying the plurality of recording media to the transport passage in the duplex printing mode, and the drying unit performs both the pre-drying and the post-drying on each of the plurality of recording media, among the plurality of recording media that continuously pass through a section in which the drying unit is disposed in the transport passage, the drying unit may perform the pre-drying on an N-th recording medium, perform the post-drying on an image formed on the first surface with respect to an (N+1)-th recording medium that is the recording medium after the image formation on the first surface, and perform the post-drying on an image formed on the second surface with respect to an (N+2)-th recording medium that is the recording medium after the image formation on the second surface.

In the image forming apparatus, the transport mechanism may include a circulation passage in which the image forming unit and the drying unit are disposed and on which the recording medium circulates in the transport passage, a supply passage through which the recording medium is supplied to the circulation passage, a discharge passage through which the recording medium is discharged from the circulation passage, and a switchback unit that temporarily pulls out the recording medium from the circulation passage to reverse a direction of travel of the recording medium, the transport mechanism may further include a first passage switching mechanism that switches a passage of the recording medium between a passage toward the discharge passage and a passage advancing on the circulation passage at a connection portion between the circulation passage and the discharge passage, and a second passage switching mechanism that switches the passage of the recording medium between a passage toward the switchback unit and a passage advancing on the circulation passage at a connection portion between the circulation passage and the switchback unit, and the processor may be configured to switch the passage of the recording medium by controlling the first passage switching mechanism and the second passage switching mechanism.

In the image forming apparatus, the processor may be configured to receive information regarding the recording medium and switch between the first mode and the second mode based on the information.

In the image forming apparatus, the information regarding the recording medium may include a moisture content of the recording medium, and the processor may be configured to: select the first mode in a case where the recording medium is a recording medium having a moisture content exceeding a preset specified moisture content; and select the second mode in a case where the recording medium is a recording medium having a moisture content equal to or less than the specified moisture content.

In this case, the specified moisture content is preferably 4.8%.

In the image forming apparatus, the information regarding the recording medium may include a thickness of the recording medium, and the processor may be configured to: select the first mode in a case where the recording medium is a recording medium having a thickness exceeding a preset specified thickness; and select the second mode in a case where the recording medium is a recording medium having a thickness less than the specified thickness.

In the image forming apparatus, the drying unit may be capable of performing, in addition to the pre-drying, post-drying of drying the image formed on the recording medium after the image is formed in the image forming unit, and the processor may be configured to control the drying unit based on the information regarding the recording medium to control a drying output in a case of performing the post-drying.

In the image forming apparatus, the processor may be configured to control the drying output of the post-drying under a condition that an organic solvent amount on the recording medium is 160 μg/cm² or less.

In the image forming apparatus, the pre-drying may be a drying step performed before a treatment on the recording medium including application of a pretreatment liquid.

In the image forming apparatus, a pretreatment liquid coating unit that applies the pretreatment liquid to an image forming surface of the recording medium before forming the image by the image forming unit, and a pretreatment liquid drying unit that dries the image forming surface to which the pretreatment liquid is applied may be further provided before the image formation by the image forming unit.

In the image forming apparatus, it is preferable that the image forming unit is a unit that forms an image by an ink jet method.

In the image forming apparatus, it is preferable that the recording medium is paper.

According to the image forming apparatus of the present disclosure, it is possible to suppress a quality defect in image formation.

### BRIEF DESCRIPTION OF THE DRAWINGS

FIG. 1 is an overall configuration diagram of an ink jet printing apparatus according to an embodiment.

FIG. 2 is an explanatory diagram of a first passage switching mechanism.

FIG. 3 is an explanatory diagram of a second passage switching mechanism.

FIG. 4 is an explanatory diagram of a switchback unit.

FIG. 5 is a functional block diagram showing a schematic configuration of a control system of the ink jet printing apparatus.

FIG. 6 is a schematic diagram of a transport passage.

FIG. 7A is a diagram showing a first transport passage.

FIG. 7B is a diagram showing a second transport passage.

FIG. 7C is a diagram showing a third transport passage.

FIG. 7D is a diagram showing a fourth transport passage.

FIG. 8 is an explanatory diagram of a table in which a paper type and a mode are associated with each other.

FIG. 9 is a flowchart of a printing process.

FIG. 10 is an explanatory diagram of an aspect example in a case where a plurality of sheets of paper are continuously supplied.

FIG. 11 is an explanatory diagram of an aspect example in a case where a plurality of sheets of paper are continuously supplied.

FIG. 12A is a diagram showing a modification example of the drying unit.

FIG. 12B is a diagram showing a modification example of the drying unit.

FIG. 12C is a diagram showing a modification example of the drying unit.

FIG. 12D is a diagram showing a modification example of the drying unit.

FIG. 12E is a diagram showing a modification example of the drying unit.

FIG. 12F is a diagram showing a modification example of the drying unit.

FIG. 12G is a diagram showing a modification example of the drying unit.

FIG. 12H is a diagram showing a modification example of the drying unit.

FIG. 12I is a diagram showing a modification example of the drying unit.

FIG. 12J is a diagram showing a modification example of the drying unit.

FIG. 12K is a diagram showing a modification example of the drying unit.

FIG. 12L is a diagram showing a modification example of the drying unit.

FIG. 13A is a diagram showing a modification example of a pretreatment liquid drying unit.

FIG. 13B is a diagram showing a modification example of the pretreatment liquid drying unit.

FIG. 13C is a diagram showing a modification example of the pretreatment liquid drying unit.

FIG. 13D is a diagram showing a modification example of the pretreatment liquid drying unit.

FIG. 13E is a diagram showing a modification example of the pretreatment liquid drying unit.

FIG. 13F is a diagram showing a modification example of the pretreatment liquid drying unit.

FIG. 14 is an overall configuration diagram of an ink jet printing apparatus of a modification example.

### DESCRIPTION OF EMBODIMENTS

Hereinafter, an embodiment of an image forming apparatus of the present disclosure will be described with reference to the drawings. In each drawing, the same elements are denoted by the same reference numerals.

### Configuration of Ink Jet Printing Apparatus 1

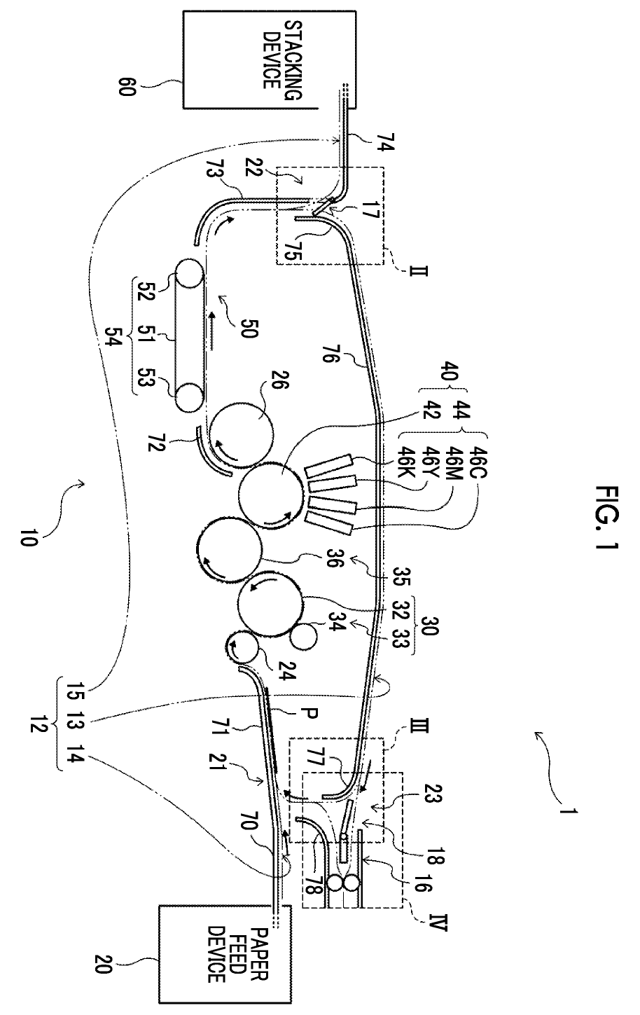

FIG. 1 is an overall configuration diagram of an ink jet printing apparatus 1 according to an embodiment of the image forming apparatus of the present disclosure. The ink jet printing apparatus 1 is an ink jet type color digital printing apparatus that forms a desired image on paper P which is cut sheet. The ink jet printing apparatus 1 comprises two printing modes including a single-sided printing mode in which an image is formed on only one surface of the paper P and a duplex printing mode in which an image is formed on both a first surface and a second surface of the paper P.

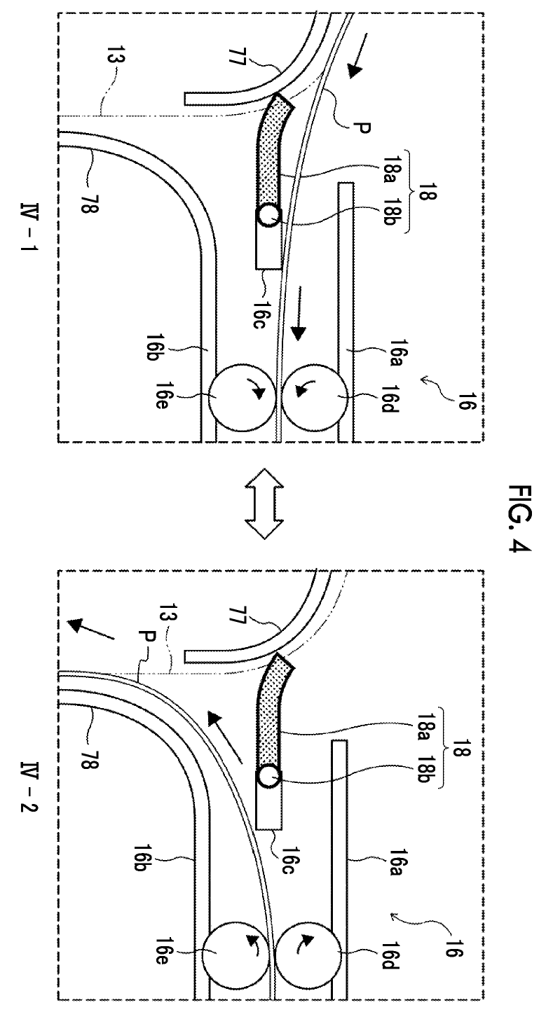

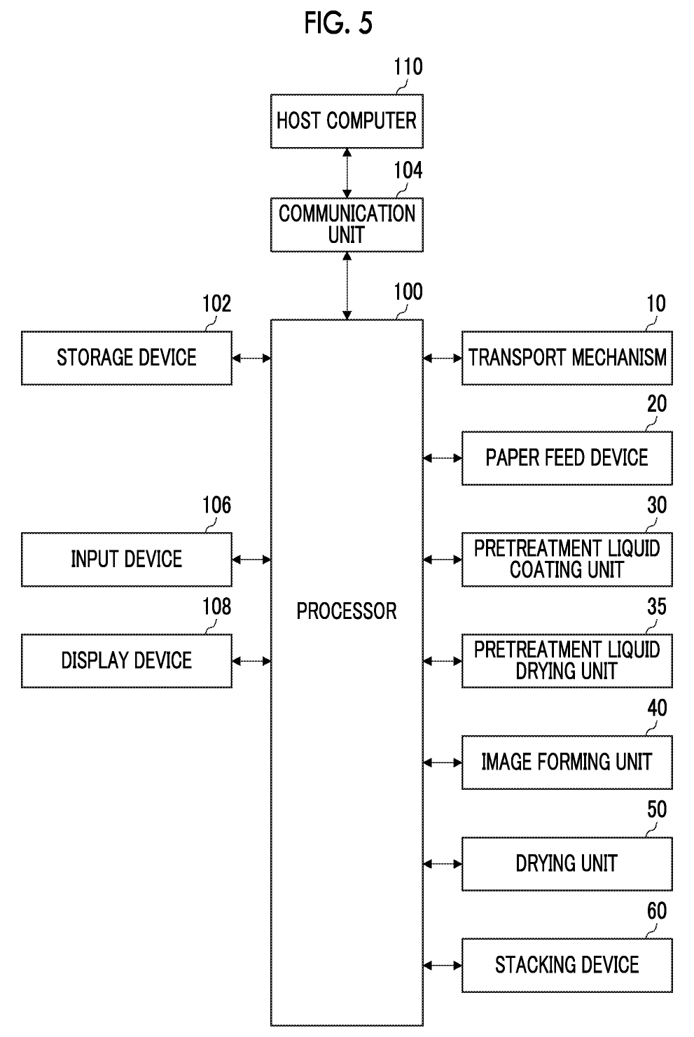

As shown in FIG. 1, the ink jet printing apparatus 1 includes a transport mechanism 10, a paper feed device 20, a pretreatment liquid coating unit 30, a pretreatment liquid drying unit 35, an image forming unit 40, a drying unit 50, and a stacking device 60. In addition, although not shown in FIG. 1, the ink jet printing apparatus 1 includes a processor 100 (see FIG. 5) as a control device.

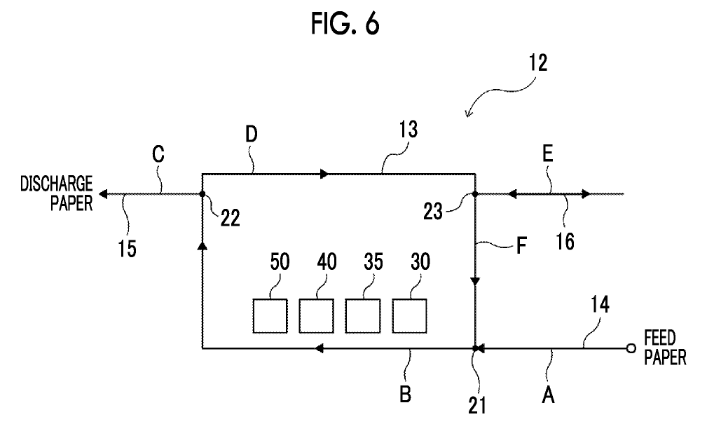

The transport mechanism 10 has a transport passage 12 for transporting the paper P. In FIG. 1, the transport passage 12 for transporting the paper P is indicated by a two-dot chain line. The transport passage 12 includes a circulation passage 13 around which the paper P circulates, a supply passage 14 for supplying the paper P to the circulation passage 13, and a discharge passage 15 for discharging the paper P from the circulation passage 13. The transport passage 12 includes a switchback unit 16 that reverses a direction of travel of the paper P, a first passage switching mechanism 17 that switches a passage of the paper P, and a second passage switching mechanism 18 that switches the passage of the paper P. The supply passage 14 is connected to the circulation passage 13 at a first connection portion 21. The discharge passage 15 is connected to the circulation passage 13 at a second connection portion 22. The switchback unit 16 is connected to the circulation passage 13 at a third connection portion 23 (see FIG. 6).

In the transport passage 12, the pretreatment liquid coating unit 30, the pretreatment liquid drying unit 35, the image forming unit 40, and the drying unit 50 are disposed between the first connection portion 21 and the second connection portion 22 on the circulation passage 13. The paper P is supplied from the supply passage 14 to the circulation passage 13 at the first connection portion 21, and sequentially passes through the pretreatment liquid coating unit 30, the pretreatment liquid drying unit 35, the image forming unit 40, and the drying unit 50 while being transported to the second connection portion 22 along the circulation passage 13.

The transport mechanism 10 includes a plurality of transport guides 70 to 78 along the transport passage 12, and also includes a chain gripper (not shown), a transport roller (not shown), and the like. In addition, the transport mechanism 10 includes a belt conveyor 54 including a paper feed drum 24, a pretreatment liquid coating drum 32, a pretreatment liquid drying drum 36, a drawing drum 42, a rotating drum 26, and a heating belt 51, which will be described later, and the like. In addition, the transport mechanism 10 includes a driving unit such as a motor (not shown) or a motor driving circuit (not shown) as a power source. The paper P is transported along the transport passage 12 by these elements constituting the transport mechanism 10.

One end of the supply passage 14 is disposed on the paper feed device 20 side, and the other end is connected to the circulation passage 13 at the first connection portion 21. The paper P is supplied from the paper feed device 20 to one end of the supply passage 14, is transported along the supply passage 14, and is supplied from the other end of the supply passage 14 to the circulation passage 13.

One end of the discharge passage 15 is connected to the circulation passage 13 at the second connection portion 22, and the other end is connected to the stacking device 60. The paper P is discharged from the circulation passage 13 to one end of the discharge passage 15, is transported along the discharge passage 15, and is discharged from the other end of the discharge passage 15 to the stacking device 60.

The first passage switching mechanism 17 is provided at the second connection portion 22 that connects the discharge passage 15 to the circulation passage 13. The first passage switching mechanism 17 switches the passage of the paper P between a passage toward the discharge passage 15 and a passage along the circulation passage 13 at the second connection portion 22.

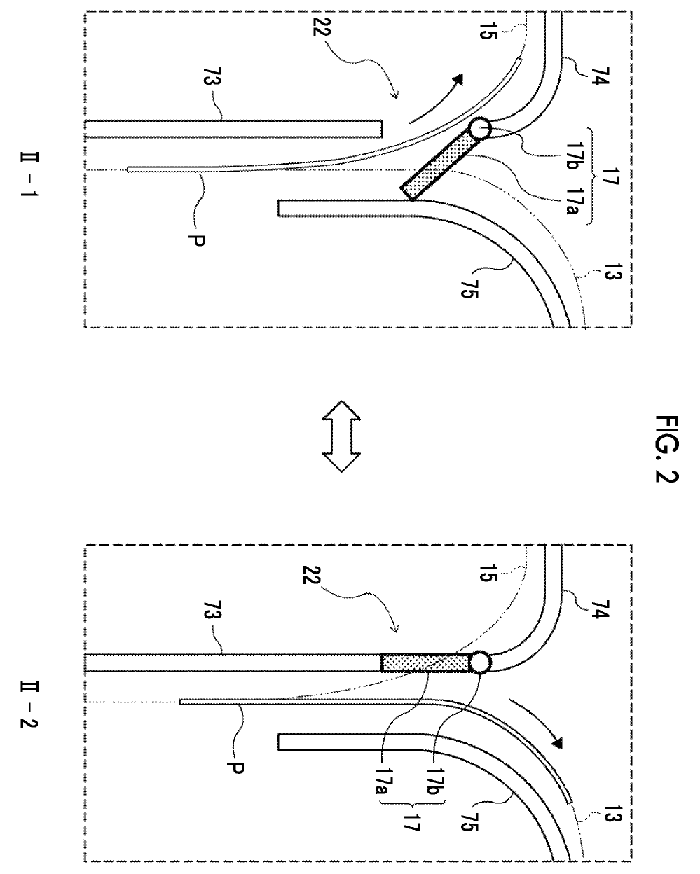

The first passage switching mechanism 17 will be described with reference to FIG. 2, which shows an enlarged view of a portion II surrounded by a broken line including the first passage switching mechanism 17. The first passage switching mechanism 17 includes, for example, a first branch guide 17a and a guide switching unit (not shown). The first branch guide 17a is rotatably fixed to a fulcrum 17b provided at one end of a transport guide 74 (to be described later). The guide switching unit rotates the first branch guide 17a to switch between a discharge state shown in II-1 in FIG. 2 and a circulation state shown in II-2 in FIG. 2. For example, an actuator such as a solenoid is used as the guide switching unit.

The discharge state in II-1 in FIG. 2 is a state in which the first branch guide 17a is rotated in a direction of coming into contact with a transport guide 75 side on the circulation passage 13 side, and the circulation passage 13 is closed and the discharge passage 15 is released. In this state, in a case where the paper P is transported to the second connection portion 22, the paper P advances toward the discharge passage 15. The circulation state shown in II-2 in FIG. 2 is a state in which the first branch guide 17a is positioned to connect between a transport guide 73 and the transport guide 74, the discharge passage 15 is closed, and the circulation passage 13 is released. In this state, the paper P transported to the second connection portion 22 is transported along the circulation passage 13 as it is.

The second passage switching mechanism 18 is provided at a third connection portion that connects the circulation passage 13 to the switchback unit 16. The second passage switching mechanism 18 switches the passage of the paper P between a passage toward the switchback unit 16 and a passage along the circulation passage 13.

The second passage switching mechanism 18 will be described with reference to FIG. 3, which shows an enlarged view of a portion III surrounded by a broken line around the second passage switching mechanism 18. The second passage switching mechanism 18 includes, for example, a second branch guide 18a and a guide switching unit (not shown). The second branch guide 18a is rotatably fixed to a fulcrum 18b provided at one end of a switchback guide 16c in the switchback unit 16, which will be described later. The guide switching unit rotates the second branch guide 18a to switch between a circulation state shown in III-1 in FIG. 3 and a switchback pull-in state shown in III-2 in FIG. 3. For example, an actuator such as a solenoid is used as the guide switching unit.

The circulation state shown in III-1 in FIG. 3 is a state in which the second branch guide 18a is rotated to a position where the second branch guide 18a blocks the passage to the pull-in port of the switchback unit 16, thereby closing the switchback unit 16 and releasing the circulation passage 13. In this state, the paper P transported to the third connection portion 23 is transported along the circulation passage 13 as it is. The switchback pull-in state shown in III-2 in FIG. 3 is a state in which the second branch guide 18a is rotated to a position where the second branch guide 18a blocks the circulation passage 13, thereby releasing the passage to the switchback pull-in port and closing the circulation passage 13. In a case where the paper P is transported to the third connection portion 23 in this state, the paper P is transported into the switchback unit 16.

The switchback unit 16 temporarily pulls out the paper P from the circulation passage 13 to reverse the direction of travel of the paper P. That is, the distal end of the paper P in the direction of travel in a case where the paper P is transported along the circulation passage 13 before being pulled into the switchback unit 16 becomes the rear end in the direction of travel after the paper P is returned to the circulation passage 13 from the switchback unit 16. In addition, in a case where the paper P is transported along the circulation passage 13 without being pulled into the switchback unit 16 at the third connection portion 23 and in a case where the paper P is returned to the circulation passage 13 after being pulled into the switchback unit 16, the front and back of the surface in contact with the transport surface are reversed.

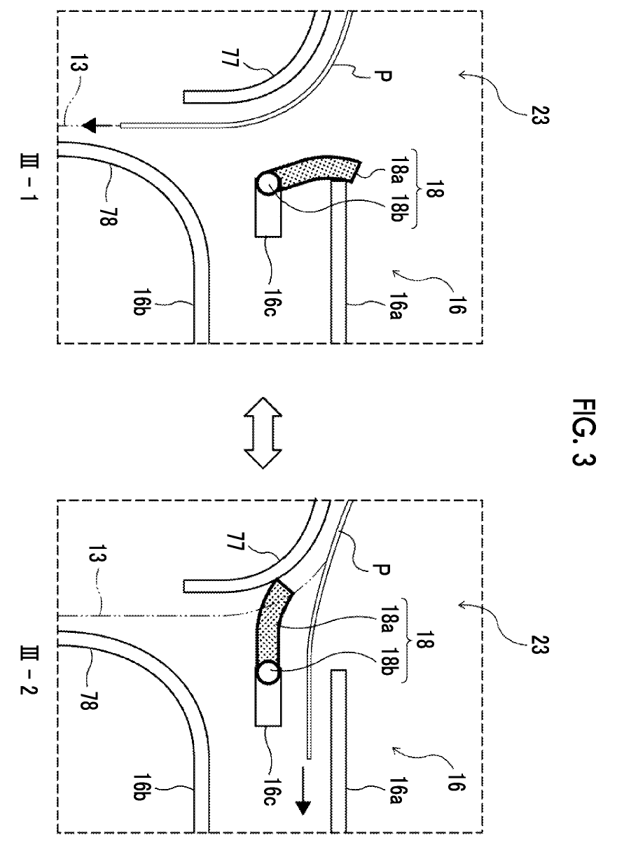

The switchback unit 16 will be described with reference to FIG. 4, which shows an enlarged view of a portion IV surrounded by a broken line including the switchback unit 16. The switchback unit 16 includes switchback guides 16a to 16c that guide the paper P and transport rollers 16d and 16e that can reverse the rotation direction. The transport rollers 16d and 16e can switch between rotation in a direction in which the paper P is pulled into the switchback guides 16a and 16b and rotation in a direction in which the paper P is discharged to the circulation passage 13 side.

The reversal of the rotation direction of the transport rollers 16d and 16e can be realized by reversing the rotation direction of the drive motor. In a case where the paper P is pulled into the switchback unit 16, as shown in IV-1 in FIG. 4, the upper transport roller 16d of the transport rollers 16d and 16e is rotated counterclockwise, and the lower transport roller 16e is rotated clockwise. On the other hand, in a case where the pulled paper P in the switchback unit 16 is returned to the circulation passage 13, as shown in IV-2 in FIG. 4, the transport rollers 16d and 16e are rotated in a direction opposite to the rotation during the pulling. That is, the upper transport roller 16d is rotated clockwise, and the lower transport roller 16e is rotated counterclockwise.

The paper feed device 20 includes a paper feed tray on which a bundle of a large number of sheets of paper is placed in a stacked state. The type of the paper P is not particularly limited, and for example, printing paper primarily containing cellulose, such as woodfree paper, coated paper, and art paper, can be used. A maximum paper size that can be used in the ink jet printing apparatus 1 is, for example, 750 mm × 585 mm.

The paper feed device 20 takes out the paper P in a state of a bundle set inside one by one in order from above and supplies the paper P to the supply passage 14 of the transport passage 12.

The pretreatment liquid coating unit 30 coats the paper P with a pretreatment liquid. There are cases where the treatment liquid is referred to as a “precoat”, a “preconditioner”, an “undercoat liquid”, a “treatment agent”, or the like. The treatment liquid is a liquid having a function of coagulating, insolubilizing, or thickening a coloring material component in the ink. The pretreatment liquid coating unit 30 includes a pretreatment liquid coating drum 32 and a pretreatment liquid coating device 33. The pretreatment liquid coating drum 32 receives the paper P from the paper feed drum 24 and transports the received paper P to the pretreatment liquid drying unit 35. The pretreatment liquid coating drum 32 includes a gripper (not shown) on the peripheral surface of the drum, and the paper P is transported by winding the paper P around the peripheral surface of the drum by gripping a tip part of the paper P with the gripper and rotating.

The pretreatment liquid coating device 33 includes a coating roller 34 and coats the paper P transported by the pretreatment liquid coating drum 32 with a pretreatment liquid. The coating roller 34 is supported by a contact/separation mechanism (not shown) that is movable between a coating position at which the coating roller 34 comes into contact with the paper P to coat the paper P with the treatment liquid and a retreat position at which the coating roller 34 is separated from the paper P and coating with the treatment liquid is not performed.

A region where the pretreatment liquid is applied to the paper P may be full-surface application where the pretreatment liquid is applied to the entire paper P, or may be partial application where the pretreatment liquid is partially applied to a region where the ink is applied in the image forming unit 40. From the viewpoint of uniformly adjusting the amount of the treatment liquid to be applied, homogeneously recording fine lines, fine image portions, and the like, and suppressing density unevenness such as image unevenness, the entire surface application in which the treatment liquid is applied to the entire image forming surface of the paper P by the coating using the coating roller or the like is preferable.

A method of applying the pretreatment liquid is not limited to the roller coating method. Other methods may be applied to the treatment liquid coating device 33. Examples of the other methods of the treatment liquid coating device 33 include coating using a blade, jetting using an ink jet method, or spraying using a spraying method.

The pretreatment liquid drying unit 35 performs a drying treatment on the paper P coated with the pretreatment liquid. The pretreatment liquid drying unit 35 includes a pretreatment liquid drying drum 36. The pretreatment liquid drying drum 36 receives the paper P from the pretreatment liquid coating drum 32 and transports the received paper P to the image forming unit 40. The pretreatment liquid drying drum 36 includes a gripper (not shown) on a drum peripheral surface. The pretreatment liquid drying drum 36 transports the paper P by rotating while gripping the tip part of the paper P by the gripper. The pretreatment liquid drying drum 36 has a peripheral surface made of a material having high thermal conductivity, such as metal, and the peripheral surface is heated by a heat source, such as a heater, provided on an inner side of the peripheral surface, so that the pretreatment liquid is dried while the paper P is transported by the pretreatment liquid drying drum 36.

The image forming unit 40 includes a drawing drum 42 and a head unit 44. The drawing drum 42 receives the paper P from the pretreatment liquid drying drum 36 and transports the received paper P to the drying unit 50 via the rotary drum 26. The drawing drum 42 includes a gripper (not shown) on a drum peripheral surface, and the paper P is wound around the drum peripheral surface and transported by gripping a tip of the paper P with the gripper and rotating. The drawing drum 42 includes an adsorption mechanism (not shown), and allows the paper P wound around the peripheral surface of the drum to be adsorbed onto the peripheral surface of the drum and transported. Negative pressure is used for the attraction. The drawing drum 42 is provided with a large number of adsorption holes on the peripheral surface, and an inside of the drawing drum 42 is suctioned through the adsorption holes to allow the paper P to be adsorbed onto the peripheral surface of the drawing drum 42.

The head unit 44 includes ink jet heads 46C, 46M, 46Y, and 46K. The ink jet head 46C is a recording head that jets droplets of cyan ink. The ink jet head 46M is a recording head that jets droplets of magenta ink. The ink jet head 46Y is a recording head that jets droplets of yellow ink. The ink jet head 46K is a recording head that jets droplets of black ink. Ink is supplied to each of the ink jet heads 46C, 46M, 46Y, and 46K from an ink tank (not shown), which is an ink supply source of the corresponding color, through a pipe passage (not shown). As the ink for drawing, for example, an aqueous ink is used. The aqueous ink refers to an ink obtained by dissolving or dispersing a coloring material such as a pigment or a dye in water and/or a water-soluble solvent.

Ink droplets are jetted from at least one of the ink jet heads 46C, 46M, 46Y, or 46K toward the paper P transported by the drawing drum 42, and the jetted droplets adhere to the paper P, whereby an image is formed on the paper P.

In this example, a configuration in which four color inks of CMYK are used is taken as an example, but the combination of the ink colors and the number of colors is not limited to the present embodiment, and light ink, dark ink, special color ink, or the like may be added as necessary. For example, a configuration in which an ink jet head that jets a light ink such as light cyan or light magenta is added, and/or a configuration in which an ink jet head that jets a special color ink such as green, orange, or white ink is added are possible. In addition, an arrangement order of the ink jet heads of each color is not particularly limited.

The drying unit 50 is capable of performing pre-drying of drying the paper P before image formation. In addition, the drying unit 50 is capable of performing post-drying of drying the image formed on the paper P, that is, evaporating the solvent of the ink after the image is formed by the image forming unit 40 in addition to the pre-drying. In the present exemplary embodiment, the pre-drying is a drying step performed before a treatment on the paper P including application of a pretreatment liquid.

The drying unit 50 heats the paper P to dry the paper P. The drying unit 50 includes, for example, a belt conveyor 54 including a heating belt 51. The belt conveyor 54 includes a driving roller 52 and a driven roller 53 in addition to the heating belt 51. The belt conveyor 54 that transports the paper P constitutes a part of the transport mechanism 10. The heating belt 51 is a belt having a transport surface made of a material having high thermal conductivity, such as metal, and is heated from a back surface side of the transport surface by a heat source such as a heater (not shown). The paper P is heated by the heating belt 51 while being transported along the heating belt 51. A temperature of the transport surface of the heating belt 51 is set to, for example, a desired temperature in a range of 80°C to 150°C, and the temperature can be changed as necessary.

The heating belt 51 has a plurality of suction holes for suction-transporting the paper P. A suction box (not shown) is disposed in a space between the driving roller 52 and the driven roller 53 on the back surface side of the transport surface of the heating belt 51. The suction box is connected to an exhaust pump (not shown). A vacuum blower such as a ring blower can be used as the exhaust pump. The suction box generates a suction pressure in the suction holes of the heating belt 51. Accordingly, the paper P can be suctioned to the transport surface.

The paper P is delivered from the drawing drum 42 to a chain gripper (not shown) via the rotating drum 26, and is placed on the heating belt 51 and suctioned to the heating belt 51 in a state in which a tip part of the paper P is gripped by the gripper. The heating belt 51 and the gripper are fed at substantially the same speed. Accordingly, the paper P is transported by the chain gripper and the heating belt 51 and is heated and dried by the heating belt 51.

The ink jet printing apparatus 1 has a first mode in which pre-drying is performed on the paper P and a second mode in which pre-drying is not performed, and the processor 100 performs control of switching between the first mode and the second mode. Specifically, the processor 100 switches between the first mode and the second mode by controlling the transport mechanism 10 to switch the transport passage of the paper P in the transport passage 12. Details of the transport passage and the processing by the processor 100 will be described later.

The stacking device 60 stacks the paper P on which the image is formed. The stacking device 60 receives the paper P discharged from the discharge passage 15 of the transport passage 12 and stacks the paper P in a bundle shape on a stacking tray (not shown).

In the present ink jet printing apparatus 1, the image formation can be sequentially performed on a plurality of sheets of paper P by continuously supplying the plurality of sheets of paper P to the transport passage 12. In the present embodiment, the pretreatment liquid coating unit 30, the pretreatment liquid drying unit 35, the image forming unit 40, and the drying unit 50 can perform the processing on each of the plurality of sheets of paper P that are continuously supplied. In addition, the drying unit 50 is configured to be capable of performing both the pre-drying and the post-drying on each of the plurality of sheets of paper P that are continuously supplied. In a case where the first mode is selected, the drying unit 50 performs the pre-drying and the post-drying on each of the plurality of sheets of paper P that are continuously supplied, and in a case where the second mode is selected, the drying unit 50 performs only the post-drying on each of the plurality of sheets of paper P that are continuously supplied.

FIG. 5 is a functional block diagram showing a schematic configuration of a control system of the ink jet printing apparatus 1. The ink jet printing apparatus 1 comprises a storage device 102, a communication unit 104, an input device 106, and a display device 108 in addition to the processor 100.

The processor 100 includes a central processing unit (CPU). The processor 100 functions as a processing unit and/or a control unit that performs various types of processing by executing an instruction of a program stored in the storage device 102. The processor 100 integrally controls the transport mechanism 10, the paper feed device 20, the pretreatment liquid coating unit 30, the pretreatment liquid drying unit 35, the image forming unit 40, the drying unit 50, and the stacking device 60.

The storage device 102 is a computer-readable medium that is a non-transitory tangible object. The storage device 102 includes a memory that is a main memory and a storage that is an auxiliary storage device. The storage device 102 may be, for example, a semiconductor memory, a hard disk drive (HDD) device, a solid state drive (SSD) device, or a combination thereof. A part or all of a storage area of the storage device 102 may be included in the processor 100.

The storage device 102 stores various parameters used in the ink jet printing apparatus 1 and programs used in each unit of the ink jet printing apparatus 1. In addition, the storage device 102 also functions as a temporary storage unit for various types of data including image data.

Various parameters stored in the storage device 102 are read out via the processor 100 and set in each unit of the apparatus. Various programs stored in the storage device 102 are read out via the processor 100 and executed in each unit of the apparatus.

The communication unit 104 comprises a required communication interface. The ink jet printing apparatus 1 is connected to a host computer 110 via the communication unit 104 and can transmit and receive data to and from the host computer 110. The term “connection” as used here includes a wired connection, a wireless connection, or a combination thereof. The communication unit 104 may be equipped with a buffer memory for increasing a speed of communication processing. The communication unit 104 has a role as an image input interface for acquiring image data representing an image of the printing target. The image data taken in from the host computer 110 via the communication unit 104 is stored in the storage device 102.

The input device 106 is configured with, for example, an operation button, a keyboard, a mouse, a touch panel, a multi-touch screen, another pointing device, a voice input device, or an appropriate combination thereof. The input device 106 receives various inputs by the operator.

The display device 108 is configured with, for example, a liquid crystal display, an organic electro-luminescence (OEL) display, a projector, or an appropriate combination thereof.

The information input via the input device 106 is sent to the processor 100. The processor 100 causes each unit to execute various types of processing in accordance with the information input from the input device 106.

The display device 108 can display various types of information such as various types of setting information of the device or abnormality information in response to a command from the processor 100. A user (operator) can set various parameters and input and edit various types of information by using the input device 106 while observing contents displayed on the display device 108.

### Transport Passage

FIG. 6 is a schematic diagram of a transport passage 12 of the paper P. As shown in FIG. 6, the transport passage 12 from paper feeding to paper discharge includes a circulation passage 13, a supply passage 14, and a discharge passage 15. In FIG. 6, for the sake of simplifying the description of the transport passage, the passages are denoted by reference numerals A to F. The supply passage 14 is composed of a passage A, the discharge passage 15 is composed of a passage C, and the switchback unit 16 is composed of a passage E. The circulation passage 13 is composed of a passage B from the first connection portion 21 to the second connection portion 22, a passage D from the second connection portion 22 to the third connection portion 23, and a passage F from the third connection portion 23 to the first connection portion 21.

As shown in FIG. 6, the pretreatment liquid coating unit 30, the pretreatment liquid drying unit 35, the image forming unit 40, and the drying unit 50 are disposed on the passage B which is a part of the circulation passage 13. As described above, the ink jet printing apparatus 1 is configured to be switchable between the first mode in which the pre-drying is performed on the paper P and the second mode in which the pre-drying is not executed. In addition, the ink jet printing apparatus 1 is configured to be selectively switchable between a single-sided printing mode and a duplex printing mode. By combining these modes, the transport passage is switched, and the paper P is transported along the transport passage suitable for each mode.

The present ink jet printing apparatus 1 includes, for example, the following four modes determined by whether the printing is single-sided or duplex and whether the pre-drying is performed or not.
(1) No pre-drying (second mode), single-sided printing
(2) Pre-drying (first mode), single-sided printing
(3) No pre-drying (second mode), duplex printing
(4) Pre-drying (first mode), duplex printing

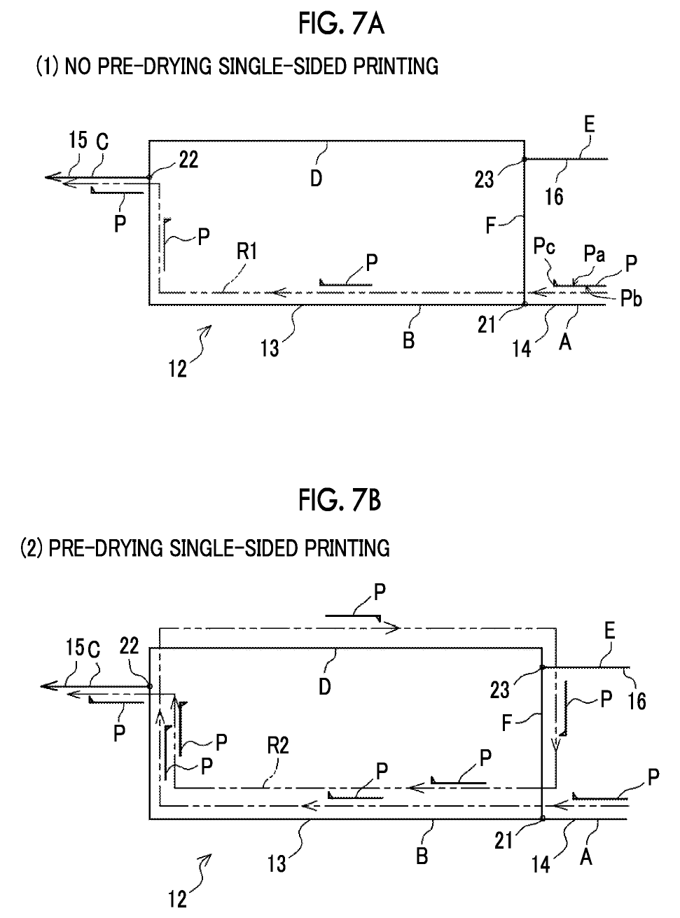

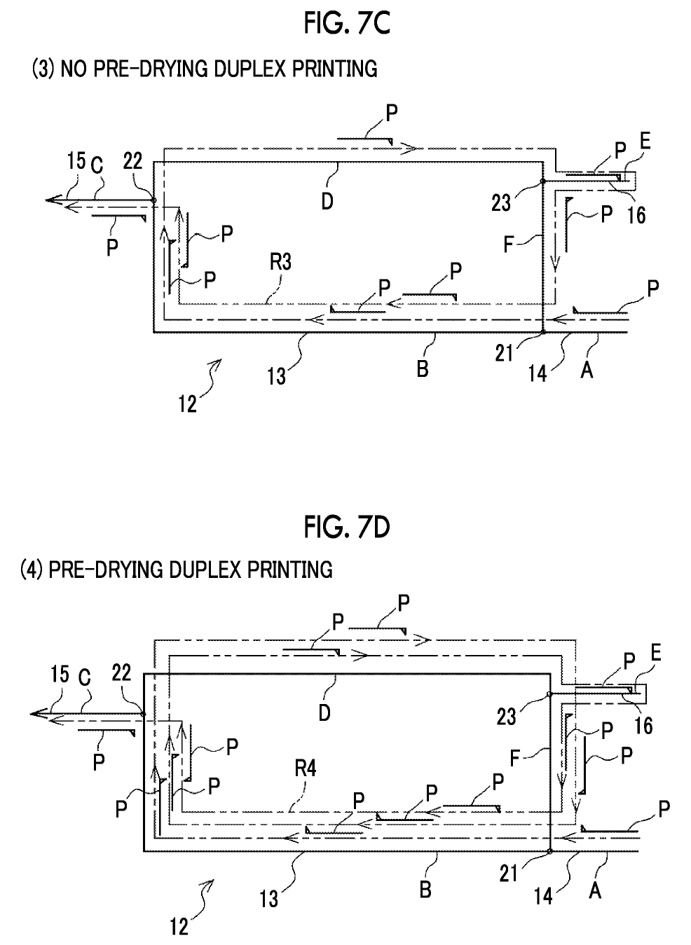

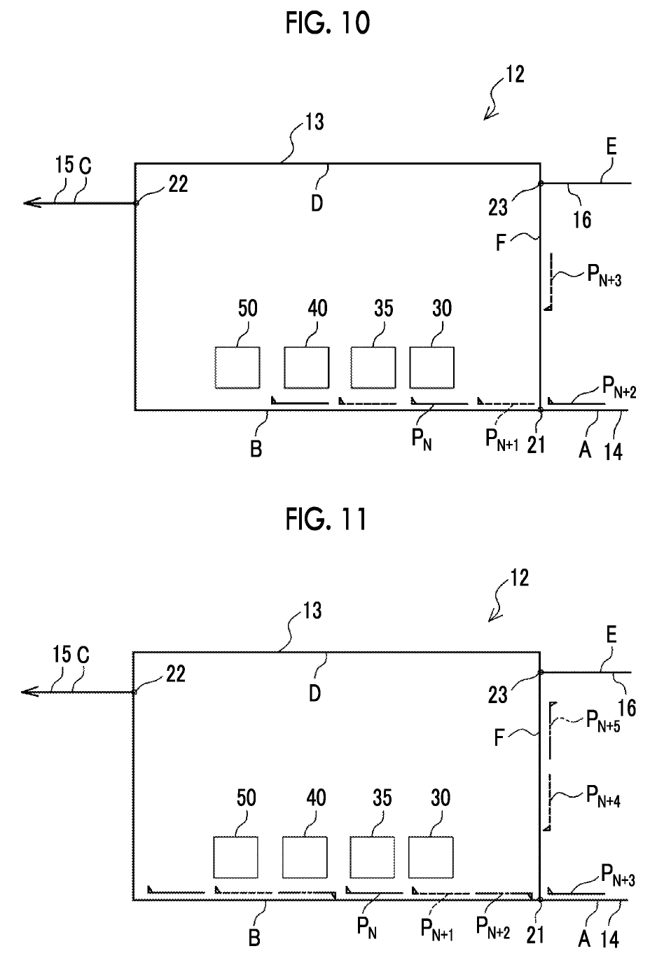

FIGS. 7A to 7D show the first transport passage R1 to the fourth transport passage R4 in each of the modes (1) to (4). In FIGS. 7A to 7D, the first transport passage R1 to the fourth transport passage R4 are shown by two-dot chain lines with respect to the transport passage 12. In FIGS. 7A to 7D, in order to clarify the orientation and the front and back of the paper P, a triangle (△) is attached to the distal end Pc in the direction of travel of the first surface Pa of the paper P in the initial state, with the orientation and the front and back of the paper P in a case of being supplied from the supply passage 14 as the initial state (see FIG. 7A). The surface to which the triangle is attached is the first surface Pa, the back surface thereof is the second surface Pb, and the end part to which the triangle is attached is the distal end Pc in the direction of travel in a case of being supplied. The same applies to FIGS. 10 and 11. In FIGS. 7A to 7D, for the sake of simplification, the pretreatment liquid coating unit 30, the pretreatment liquid drying unit 35, the image forming unit 40, and the drying unit 50 are omitted, but as described above, these units are disposed on the passage B, and the processing by each unit is appropriately executed while the paper P passes through the passage B.

(1) In a mode of no pre-drying and single-sided printing, the paper P is transported through the first transport passage R1 passing through the passage A-B-C. That is, in this mode, the paper P does not make one round of the circulation passage 13, and passes through only the passage B which is a part of the circulation passage 13.

Since there is no pre-drying, for the paper P supplied from the passage A to the passage B, the pretreatment liquid is applied to one side (here, the first surface Pa) by the pretreatment liquid coating unit 30, the pretreatment liquid is dried by the pretreatment liquid drying unit 35, the image formation is performed on one side by the image forming unit 40, and the post-drying is performed by the drying unit 50 in the passage B in this order. Thereafter, the paper P on which the image is printed on one side is discharged from the passage C without making one round of the circulation passage 13.

(2) In a mode of pre-drying and single-sided printing, the paper P is transported through the second transport passage R2 passing through the passage A-B-D-F-B-C. That is, in this mode, the paper P passes through the passage B of the circulation passage 13 twice and makes one and a half rounds of the circulation passage 13.

Since there is pre-drying, in a case where the paper P supplied from the passage A to the passage B passes through the passage B for the first time, the application of the pretreatment liquid to the paper P and the image formation are not executed, and only the pre-drying by the drying unit 50 is performed. The paper P is transported to the passage B again through the passages D and F, and in a case where the paper P passes through the passage B for the second time, the pretreatment liquid is applied to one side (here, the first surface Pa), the pretreatment liquid is dried, the image formation is performed on one side, and the post-drying is performed in this order. Thereafter, the paper P on which the image is printed on one side is discharged from the passage C.

(3) In a mode of no pre-drying and duplex printing, the paper P is transported through the third transport passage R3 passing through the passage A-B-D-E-E-F-B-C. In this mode, the paper P passes through the passage B of the circulation passage 13 twice and makes one and a half rounds of the circulation passage 13. In this case, by passing through the switchback unit 16 in the middle, the front and rear ends and the front and back surfaces of the paper are reversed between the first passing and the second passing in a case where the paper passes through the passage B.

Since the pre-drying is not performed, in a case where the paper P supplied from the passage A to the passage B passes through the passage B for the first time, the application of the pretreatment liquid to the first surface Pa which is one side of the paper P, the drying of the pretreatment liquid, the image formation on the first surface Pa, and the post-drying are performed in this order. The paper P is drawn into the switchback unit 16 from the passage B through the passage D and reciprocates through the passage E, so that the front and rear ends of the paper P and the front and back surfaces in a case where the paper P passes through the passage B are reversed. In a case where the paper P passes through the passage B for the second time, the second surface Pb which is the back surface of the first surface Pa of the paper P is the image forming surface, and the application of the pretreatment liquid to the second surface Pb, the drying of the pretreatment liquid, the image formation on the second surface Pb, and the post-drying are performed in this order. Then, the paper P on which the images are printed on both sides is discharged from the passage C.

(4) In a mode of pre-drying and duplex printing, the paper P is transported through the fourth transport passage R4 passing through the passage A-B-D-F-B-D-E-E-F-B-C. In this mode, the paper P passes through the passage B of the circulation passage 13 three times and makes two and a half rounds of the circulation passage 13. In this case, by passing through the switchback unit 16 in the middle of the second round, the front and rear ends and the front and back surfaces of the paper P in a case where the paper P passes through the passage B are reversed between the first and second times and the third time.

Since the pre-drying is performed by the drying unit 50, in a case where the paper P supplied from the passage A passes through the passage B for the first time, the application of the pretreatment liquid to the paper P and the image formation are not executed, and only the pre-drying by the drying unit 50 is performed. The paper P is transported to the passage B again through the passages D and F, and in a case where the paper P passes through the passage B for the second time, the application of the pretreatment liquid to the first surface Pa which is one side, the drying of the pretreatment liquid, the image formation on the first surface Pa, and the post-drying are performed in this order. The paper P passes through the passage D again, is then drawn into the switchback unit 16, and reciprocates through the passage E, so that the front end and the rear end in the direction of travel are reversed, and the front and back surfaces in a case where the paper P passes through the passage B for the third time are reversed. In a case where the paper P passes through the passage B for the third time, the second surface Pb which is the back surface of the first surface Pa of the paper P is the image forming surface, and the application of the pretreatment liquid to the second surface Pb, the drying of the pretreatment liquid, the image formation on the second surface Pb, and the post-drying are performed in this order. Then, the paper P on which the images are printed on both the first surface Pa and the second surface Pb is discharged from the passage C.

As described above, the modes (1) to (4) are switched by switching to the first transport passage R1 to the fourth transport passage R4. As in the first transport passage R1 to the fourth transport passage R4 shown in FIGS. 7A to 7D, at least a part of the transport passage 12 is shared in the single-sided printing modes of (1) and (2) and the duplex printing modes of (3) and (4).

The first transport passage R1 to the fourth transport passage R4 in the modes (1) to (4) are examples, and the transport passages in each mode are not limited to the above. For example, in order to increase the strength after printing, the mode of (1) may be realized by a transport passage passing through the passage A-B-D-F-B-C in which the circulation passage 13 is circulated one and a half times, and the configuration may be made such that the post-drying is performed again on the second passage B after the printing on one side is performed on the first passage B.

### “Processing by Processor 100”

The processor 100 receives the designation of whether to perform the single-sided printing or the duplex printing from the input device 106. In addition, the processor 100 receives, for example, the information regarding the paper P from the input device 106, and switches between the first mode in which the pre-drying is performed and the second mode in which the pre-drying is not performed, based on the information. Here, switching between the first mode and the second mode means setting the first mode or the second mode based on the information on the paper P. The processor 100 sets the transport passage of the paper P to, for example, the transport passage according to the first mode or the transport passage according to the second mode.

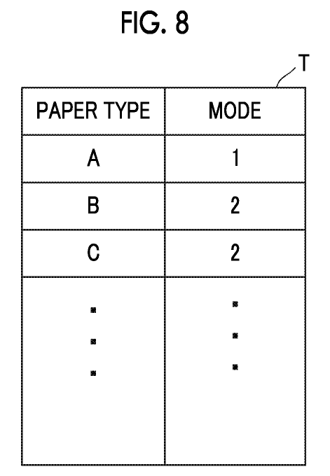

The information on the paper P is, for example, the type of the paper P. Examples of the type of the paper include high-quality paper, coated paper, and art paper. A table T shown in FIG. 8 in which the type of the paper used in the ink jet printing apparatus 1 and the necessity of the pre-drying are associated with each other is stored in the storage device 102 in advance. In the table T shown in FIG. 8, the first mode is associated with a case where the type of the paper is "A", the second mode is associated with a case where the type of the paper is "B", and the second mode is associated with a case where the type of the paper is "C”. The processor 100 receives the type of the paper P, reads out the table T from the storage device 102, and sets the first mode or the second mode. For example, in a case where the input type of the paper P is "A", the first mode is set, and in a case where the type of the paper P is "B", the second mode is set.

In a case where the table T is created in advance, for example, the paper having an average moisture content equal to or greater than a specified moisture content is set to the first mode, and the paper having an average moisture content less than the specified moisture content is set to the second mode. The specified moisture content is, for example, 5%, 4.8%, 4.5%, or the like, and 4.8% is particularly preferable. In the present specification, the "moisture content" means a proportion (moisture content) of moisture contained in the paper P. In addition, the type and the thickness of the paper may be combined, and for example, the paper that is coated paper and has a thickness equal to or greater than a specified thickness may be set to the first mode, and the paper that has a thickness less than the specified thickness may be set to the second mode. The specified thickness varies depending on the type of the paper, and for example, in a case where the type of the paper is gloss coated paper, the specified thickness is 0.188 mm.

In addition, the information regarding the paper P to be received may include the moisture content of the paper P. The processor 100 receives the moisture content of the paper P as the information regarding the paper P, and sets the first mode (that is, pre-drying is performed) in a case where the received moisture content is equal to or greater than the specified moisture content, and sets the second mode (that is, pre-drying is not performed) in a case where the received moisture content is less than the specified moisture content. The specified moisture content can be freely set. Here, the specified moisture content is, for example, 5%, 4.8%, or 4.5%, and 4.8% is particularly preferable. The specified moisture content is stored in the storage device 102 in advance, and in a case where the moisture content is received as the information regarding the paper, the processor 100 reads out the specified moisture content from the storage device 102, compares the received moisture content with the specified moisture content, and sets the first mode or the second mode. The operator may input the general moisture content of the paper P from the input device 106, or may input the moisture content measured by the moisture meter before the paper P is set in the paper feed device 20.

In addition, the information regarding the paper P to be received may include the thickness of the paper P. In a case where the type of the paper P to be used is set by default, the processor 100 receives the thickness of the paper P as the information regarding the paper P, and sets the first mode in a case where the thickness is equal to or greater than the specified thickness, and sets the second mode in a case where the thickness is less than the specified thickness. The specified thickness is stored in the storage device 102 in advance, and in a case where the thickness is received as the information regarding the paper, the processor 100 reads out the specified thickness from the storage device 102, compares the received thickness with the specified thickness, and sets the first mode or the second mode. The information regarding the paper P may be a combination of the type and the thickness of the paper.

The processor 100 performs the mode setting of (1) to (4) described above based on the information from the input device 106 as described above. That is, the processor 100 controls the transport mechanism 10 to switch the transport passage to any of the first transport passage R1 to the fourth transport passage R4. The switching of the transport passage to the first transport passage R1 to the fourth transport passage R4 is realized by switching the first branch guide 17a of the first passage switching mechanism 17, switching the second branch guide 18a of the second passage switching mechanism 18, and/or switching the rotation direction of the transport rollers 16d and 16e of the switchback unit 16.

The transport mechanism 10 includes elements of the mechanism related to the transport of the paper P from the paper feed device 20 to the stacking device 60 described in FIG. 1. Specifically, the transport mechanism 10 includes the paper feed drum 24, the pretreatment liquid coating drum 32, the pretreatment liquid drying drum 36, the drawing drum 42, the rotating drum 26, the belt conveyor 54, a chain gripper (not shown), a transport roller (not shown), and the like shown in FIG. 1. In addition, the transport mechanism 10 includes a driving unit such as a motor (not shown) or a motor driving circuit (not shown) as a power source. The processor 100 controls each element of the transport mechanism 10 to transport the paper P from the paper feed device 20 to the stacking device 60 according to the set transport passage. The processor 100 controls the paper feed start operation of the paper P by the paper feed device 20, the paper feed stop operation of the paper P, and the like.

The processor 100 performs various types of conversion processing, correction processing, and image processing such as halftone processing on the image data to be printed.

The processor 100 operates the pretreatment liquid coating unit 30 and the pretreatment liquid drying unit 35. The processor 100 controls the coating operation of the pretreatment liquid coating device 33, such as the application amount and the application timing of the pretreatment liquid. The processor 100 controls the pretreatment liquid drying unit 35 to control the drying output, the drying time, and the like.

The drying output is an output of a heat source, and is, for example, a heater output in a case where the heat source is a heater, and is a temperature of hot air blown out from a hot air blower and a flow rate of the hot air in a case where the heat source is a hot air blower.

The processor 100 operates the image forming unit 40. The processor 100 controls the ejection operation of each of the ink jet heads 46C, 46M, 46Y, and 46K such that the image is recorded on the paper P transported by the drawing drum 42, based on the dot data of each ink color generated through the image processing.

In addition, the processor 100 operates the drying unit 50. The processor 100 controls the drying unit 50 to control the drying output and/or the drying time. It is preferable that the processor 100 controls the drying unit 50 based on the information regarding the paper P to control the drying output in a case of performing the post-drying. In this case, it is preferable that the processor 100 controls the drying output of the post-drying under a condition that an organic solvent amount on the paper P is 160 μg/cm² or less. For example, a table in which the type of the paper P and the drying condition are associated with each other, which is created by examining the type of the paper P and the drying condition in which the amount of the organic solvent is 160 μg/cm² or less in advance, is stored in the storage device 102. Then, the processor 100 receives the type of the paper P as the information regarding the paper P, reads out the table from the storage device 102, and performs control such that the corresponding drying output is obtained.

In addition, the processor 100 may control the drying output and/or the drying time in a case of performing the pre-drying, based on the type, the moisture content, the thickness, or the like of the paper as the information regarding the input paper P. For example, a table in which the information regarding the paper P and the drying output of the pre-drying are associated with each other is stored in the storage device 102 in advance, and the processor 100 receives the information regarding the paper P, reads out the table from the storage device 102, and controls the drying unit 50 such that the corresponding drying output is obtained. In addition, the processor 100 may receive the information regarding the paper P and control the drying unit 50 such that the drying output is set to be higher as the moisture content is higher and the drying output is set to be lower as the moisture content is lower, or the drying output is set to be higher as the thickness is thicker and the drying output is set to be lower as the thickness is thinner, according to the information.

As a hardware structure of the processor 100, various processors shown below can be used. Various processors include a programmable logic device (PLD) that is capable of changing a circuit configuration after manufacturing, such as a field-programmable gate array (FPGA), and a dedicated electric circuit that is a processor having a circuit configuration dedicatedly designed for executing specific processing, such as an application specific integrated circuit (ASIC), in addition to a CPU that is a general-purpose processor configured to execute software (program) to function as various processing units.

The processing described above may be executed by one of the various processors or may be executed by a combination of two or more processors (for example, a combination of a plurality of FPGAs or a CPU and an FPGA) of the same type or different types. Alternatively, a plurality of processing units may be composed of one processor. As an example in which the plurality of processing units are configured of one processor, there is a form in which a processor that realizes all functions of a system including the plurality of processing units by using one integrated circuit (IC) chip is used, such as a system on chip (SOC).

Furthermore, as the hardware structure of these processors, more specifically, an electric circuit (circuitry) in which circuit elements such as semiconductor elements are combined can be used.

### Printing Process Flow in Ink Jet Printing Apparatus 1

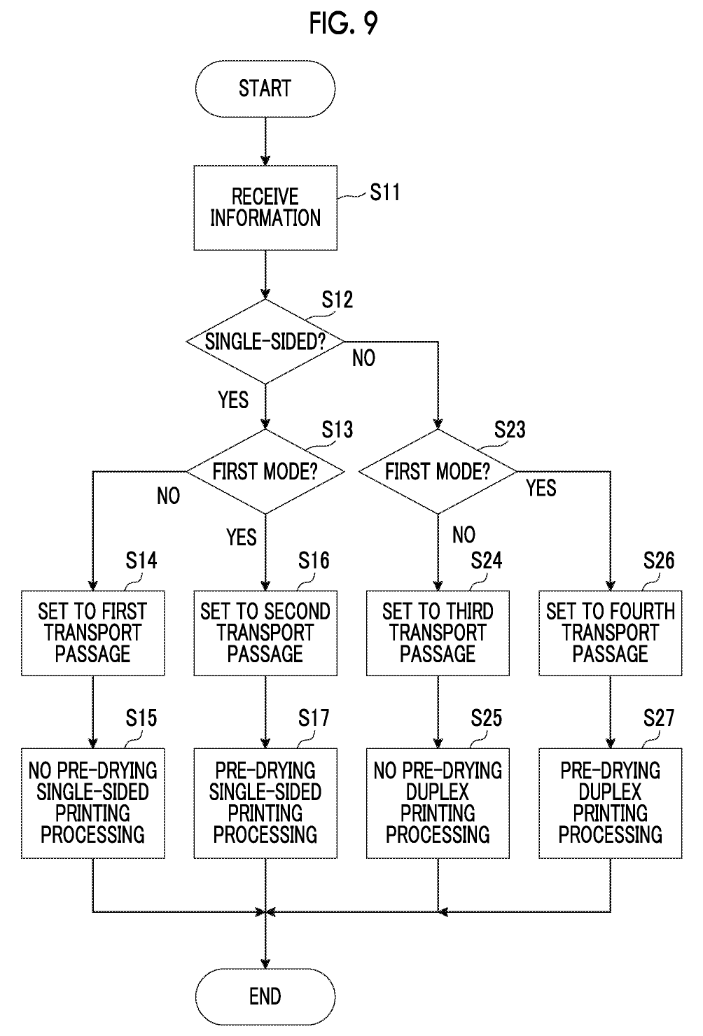

An example of a flow of the printing process in the ink jet printing apparatus 1 will be described with reference to FIG. 9.

First, in step S11, the processor 100 receives information regarding the paper P and information regarding whether to perform single-sided printing or duplex printing. For example, the processor 100 receives the input of the information regarding the paper P and the information for designating whether to perform single-sided printing or duplex printing from the input device 106.

In step S12, the processor 100 determines whether to perform single-sided printing or duplex printing. In a case where the determination result in step S12 is “single-sided printing”, the process proceeds to step S13.

In step S13, the processor 100 determines whether or not it is the first mode, that is, with the pre-drying, based on the information regarding the paper P. Here, not being the first mode means being the second mode, that is, without the pre-drying.

In a case where the determination result in step S13 is not “first mode”, the process proceeds to step S14. In step S14, the processor 100 controls the transport mechanism 10 to set the transport passage to the first transport passage R1 for executing the mode of (1) no pre-drying and single-sided printing. Next, in step S15, the processor 100 controls the transport mechanism 10, the paper feed device 20, the pretreatment liquid coating unit 30, the pretreatment liquid drying unit 35, the image forming unit 40, the drying unit 50, and the stacking device 60 to execute the single-sided printing process without pre-drying.

On the other hand, in a case where the determination result in step S13 is “first mode”, the process proceeds to step S16. In step S16, the processor 100 controls the transport mechanism 10 to set the transport passage to the second transport passage R2 for executing the mode of (2) pre-drying and single-sided printing. Next, in step S17, the processor 100 controls the transport mechanism 10, the paper feed device 20, the pretreatment liquid coating unit 30, the pretreatment liquid drying unit 35, the image forming unit 40, the drying unit 50, and the stacking device 60 to execute the single-sided printing process with pre-drying.

In a case where the determination result in step S12 is not “single-sided printing”, that is, in a case where the determination result is “duplex printing”, the process proceeds to step S23, and in step S23, the processor 100 determines whether it is the first mode, that is, with the pre-drying, or the second mode, that is, without the pre-drying, based on the information regarding the paper P.

In a case where the determination result in step S23 is not “first mode”, the process proceeds to step S24. In step S24, the processor 100 controls the transport mechanism 10 to set the transport passage to the third transport passage R3 for executing the mode of (3) no pre-drying and duplex printing. Next, in step S25, the processor 100 controls the transport mechanism 10, the paper feed device 20, the pretreatment liquid coating unit 30, the pretreatment liquid drying unit 35, the image forming unit 40, the drying unit 50, and the stacking device 60 to execute the duplex printing process without pre-drying.

In a case where the determination result in step S23 is “first mode”, the process proceeds to step S26. In step S26, the processor 100 controls the transport mechanism 10 to set the transport passage to the fourth transport passage R4 for executing the mode of (4) pre-drying and duplex printing. Next, in step S27, the processor 100 controls the transport mechanism 10, the paper feed device 20, the pretreatment liquid coating unit 30, the pretreatment liquid drying unit 35, the image forming unit 40, the drying unit 50, and the stacking device 60 to execute the duplex printing process with pre-drying.

As described above, the printing process is executed in any mode, and the printing process is ended.

As described above, the ink jet printing apparatus 1 according to the present embodiment comprises the transport mechanism 10, the image forming unit 40, the drying unit 50, and the processor 100 that controls these, and the processor 100 can switch between the first mode in which the pre-drying is performed on the recording medium (in the present example, the paper P) and the second mode in which the pre-drying is not performed. With such a configuration, the presence or absence of the pre-drying can be set according to the recording medium, and thus the quality defect of the image formation can be suppressed. By setting the second mode in which the pre-drying is not performed on the recording medium for which the pre-drying is unnecessary, the throughput can be improved, and the deformation of the recording medium due to the over-drying can be suppressed. By performing the pre-drying on the recording medium that requires the pre-drying, the drying time after the image formation can be shortened.

In the ink jet printing apparatus 1 of the above-described embodiment, since the pre-drying and the post-drying are performed using the same drying unit 50, it is possible to reduce the unit cost, reduce the power consumption, and reduce the size of the apparatus, as compared with a case where the drying unit is provided for each of the pre-drying and the post-drying.

In the ink jet printing apparatus 1 of the above-described embodiment, the processor 100 can switch the passage (transport passage) through which the recording medium is transported by controlling the transport mechanism 10, and switches between the first mode and the second mode by switching the transport passage. In this way, since the first mode and the second mode are switched by switching the transport passage, the configuration of the apparatus may be simplified as compared with a case where the presence or absence of the pre-drying is switched by a method other than the switching of the transport passage.

In the ink jet printing apparatus 1 of the above-described embodiment, the processor 100 is configured to receive the information regarding the recording medium and switch between the first mode and the second mode based on the information. Since the operator inputs only the information regarding the recording medium, the mode suitable for the recording medium is set in the ink jet printing apparatus 1, and the printing process is executed, and thus the burden on the operator is small.

In the ink jet printing apparatus 1 of the above-described embodiment, since the plurality of sheets of paper P are continuously supplied to the transport passage 12, the image formation can be sequentially performed on the plurality of sheets of paper P, and thus the throughput is improved. Since the drying unit 50 is shared for both the pre-drying and the post-drying for each of the plurality of sheets of paper P, the configuration of the apparatus can be simplified.

FIGS. 10 and 11 show specific aspect examples in a case where the plurality of sheets of paper P are continuously supplied to the transport passage 12.

As shown in FIG. 10, in the transport passage 12, it is preferable that the sheet of paper P indicated by a solid line on which the pre-drying is performed in the drying unit 50 and the sheet of paper P indicated by a broken line on which the post-drying is performed are alternately supplied to the passage B which is a section in which the units 30, 35, 40, and 50 are disposed. This can be realized by controlling the transport timing of the sheet of paper P such that the supply of the sheet of paper P (in FIG. 10, the sheet of paper P_{N+2}) from the passage A to the passage B of the circulation passage 13 in the first connecting portion 21 and the transfer of the sheet of paper P (in FIG. 10, the sheet of paper P_{N+3}) from the passage F to the passage B in the circulation passage 13 are alternated. Here, the sheet of paper P supplied from the passage A to the passage B is a sheet of paper on which the pre-drying is performed, and the sheet of paper P2 transferred from the passage F to the passage B is a sheet of paper on which the pre-drying is ended and the image formation and the post-drying are performed. For example, a case where the pre-drying is performed in the single-sided printing mode is assumed as the continuous transport of such sheets of paper.

According to the configuration shown in FIG. 10, the drying unit 50 performs the pre-drying on, for example, the N-th sheet of paper P_{N} among the plurality of sheets of paper P₁, P₂, ..., P_{N}, and P_{N+1} ..., which continuously pass through the section in which the drying unit 50 is disposed in the transport passage 12, that is, the passage B, and performs the post-drying on the (N+1)-th sheet of paper P_{N+1}. According to such a configuration, the throughput can be improved as compared with a case where the next sheet of paper P is supplied after both the pre-drying and the post-drying for one sheet of paper P are ended.

In addition, in a case of the pre-drying in the duplex printing mode of (4), as shown in FIG. 11, in the transport passage 12, it is preferable that the sheet of paper P indicated by a solid line on which the pre-drying is performed in the drying unit 50, the sheet of paper P indicated by a broken line on which the post-drying for the first surface Pa is performed, and the sheet of paper P indicated by a one-dot chain line on which the post-drying for the second surface Pb is performed are sequentially supplied to the passage B which is a section in which the units 30, 35, 40, and 50 are disposed. This can be realized by controlling the transport timing of the sheet of paper P such that the supply of the sheet of paper P (in FIG. 11, the sheet of paper P_{N+3}) from the passage A to the passage B, which is the supply passage, in the first connecting portion 21, the transfer of the sheet of paper P (in FIG. 10, the sheet of paper P_{N+4}) from the passage F to the passage B without being switched back in the circulation passage, and the transfer of the sheet of paper P (in the figure, the sheet of paper P_{N+5}) from the passage F to the passage B by being switched back in the circulation passage are sequentially performed. Here, the sheet of paper P supplied from the passage A to the passage B is a sheet of paper on which the pre-drying is performed. The sheet of paper P transferred from the passage F to the passage B without being switched back is a sheet of paper on which the pre-drying is ended and the image formation on the first surface Pa and the post-drying are performed. The sheet of paper P transferred from the passage F to the passage B by being switched back is a sheet of paper on which the image formation on the first surface Pa is performed and the image formation on the second surface Pb and the post-drying are performed.

According to the configuration shown in FIG. 11, the drying unit 50 performs the pre-drying on the N-th sheet of paper P_{N} among the plurality of sheets of paper P₁, P₂, ..., P_{N}, and P_{N+1} ..., which continuously pass through the section in which the drying unit 50 is disposed in the transport passage 12, that is, the passage B, performs the post-drying for the image formed on the first surface Pa on the (N+1)-th sheet of paper P_{N+1}, and performs the post-drying for the image formed on the second surface Pb on the (N+2)-th sheet of paper P_{N+2}. According to such a configuration, the throughput can be improved in the duplex printing mode.

### Modification Example of Drying Unit 50

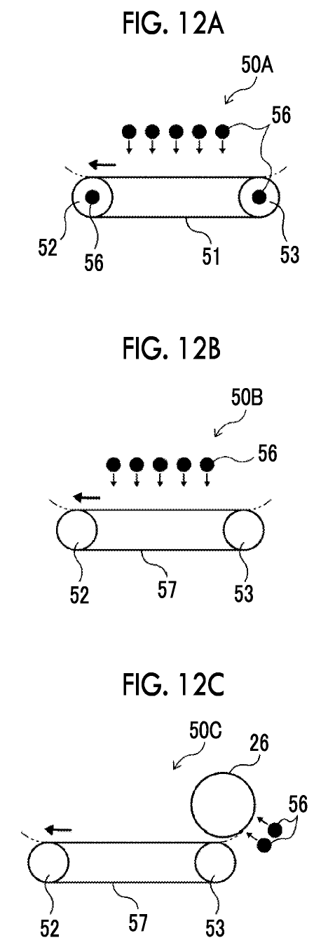

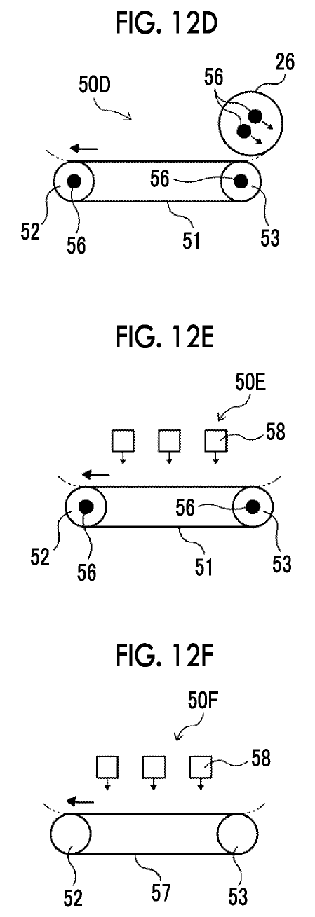

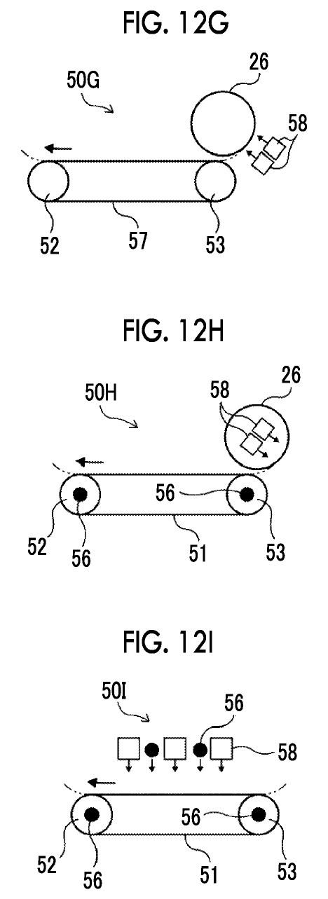

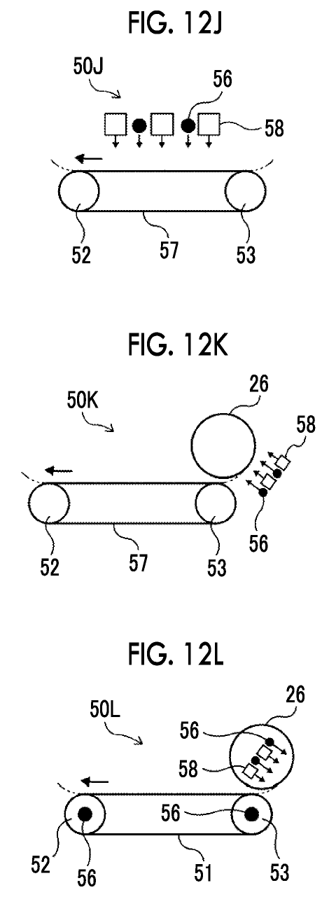

In the above-described embodiment, the form has been described in which the drying unit 50 comprises the heating belt 51 and the sheet of paper P is heated and dried by the heating belt 51, but the configuration of the drying unit 50 is not limited thereto. The drying unit 50 may comprise any of a heat roller, a hot air blower, an infrared (IR) heater, a microwave generator, a superheated steam generator, a UV lamp, an IR lamp, or the like as long as the device has an effect of reducing the moisture of the sheet of paper P. The drying unit 50 may comprise a plurality of devices that reduce the moisture of the sheet of paper P in combination as long as the devices are not limited to one type. FIGS. 12A to 12L show drying units 50A to 50L of modification examples.

As shown in FIG. 12A, the drying unit 50A may comprise an infrared (IR) heater 56 inside the driving roller 52 and the driven roller 53 and at a position facing the transport surface of the heating belt 51, in addition to the heating belt 51. In this case, the drying unit 50A can heat and dry the sheet of paper P transported on the heating belt 51 from both the front and back surfaces.

As shown in FIG. 12B, the drying unit 50B may have a configuration comprising a normal transport belt 57 without comprising the heating belt 51, and comprising only the IR heater 56 disposed at a position facing the transport surface of the transport belt 57. In this case, the drying unit 50B heats and dries the sheet of paper P transported on the transport belt 57 by the IR heater 56. Here, the normal transport belt 57 means a belt in which the transport surface is not formed of a material having a high thermal conductivity, such as metal.

As shown in FIG. 12C, the drying unit 50C may have a configuration comprising a normal transport belt 57 without comprising the heating belt 51, and comprising only the IR heater 56 disposed to face the rotating drum 26 that receives the sheet of paper P from the drawing drum 42. In this case, the drying unit 50C heats and dries the sheet of paper P adsorptively transported by the rotating drum 26 by the IR heater 56.

As shown in FIG. 12D, the drying unit 50D may comprise the IR heater 56 inside the rotating drum 26 that receives the sheet of paper P from the drawing drum 42, in addition to the heating belt 51. In this case, the drying unit 50D heats and dries the sheet of paper P transported to the rotating drum 26 by the IR heater 56, and heats and dries the sheet of paper P transported on the heating belt 51.

As shown in FIG. 12E, the drying unit 50E may comprise infrared (IR) heaters 56 inside the driving roller 52 and the driven roller 53, in addition to the heating belt 51, and may comprise the hot air blower 58 disposed to face the transport surface of the heating belt 51. In this case, the drying unit 50E can heat and dry the sheet of paper P transported on the heating belt 51 from both the front and back surfaces.

As shown in FIG. 12F, the drying unit 50F may have a configuration not comprising the heating belt 51 but comprising only the hot air blower 58 disposed to face the normal transport belt 57. In this case, the drying unit 50F heats and dries the sheet of paper P by blowing hot air from the hot air blower 58 to the sheet of paper P transported on the transport belt 57.

As shown in FIG. 12G, the drying unit 50G may have a configuration comprising a normal transport belt 57 without comprising the heating belt 51, and comprising only the hot air blower 58 disposed to face the rotating drum 26 that receives the sheet of paper P from the drawing drum 42. In this case, the drying unit 50G heats and dries the sheet of paper P adsorptively transported to the rotating drum 26 by blowing hot air from the hot air blower 58.

As shown in FIG. 12H, the drying unit 50H may comprise the IR heater 56 inside the driving roller 52 and the driven roller 53, in addition to the heating belt 51, and may comprise the hot air blower 58 disposed inside the rotating drum 26 that receives the sheet of paper P from the drawing drum 42. In this case, the drying unit 50H heats and dries the sheet of paper P adsorptively transported to the rotating drum 26 by blowing hot air from the hot air blower 58 from the rotating drum 26 side, and heats and dries the sheet of paper P transported on the heating belt 51.

As shown in FIG. 12I, the drying unit 50I may comprise the IR heater 56 inside the driving roller 52 and the driven roller 53, in addition to the heating belt 51, and may comprise the IR heater 56 and the hot air blower 58 disposed to face the transport surface of the heating belt 51. In this case, the drying unit 50I can heat and dry the sheet of paper P transported on the heating belt 51 from the front and back surfaces.

As shown in FIG. 12J, the drying unit 50J may have a configuration comprising a normal transport belt 57 without comprising the heating belt 51, and comprising the IR heater 56 and the hot air blower 58 disposed to face the normal transport belt 57. In this case, the drying unit 50J heats and dries the sheet of paper P transported on the transport belt 57 by heating the sheet of paper P with the IR heater 56 and blowing hot air from the hot air blower 58 to the sheet of paper P.

As shown in FIG. 12K, the drying unit 50K may have a configuration comprising a normal transport belt 57 without comprising the heating belt 51, and comprising the IR heater 56 and the hot air blower 58 disposed to face the rotating drum 26 that receives the sheet of paper P from the drawing drum 42. In this case, the drying unit 50K heats and dries the sheet of paper P transported to the rotating drum 26 by heating the sheet of paper P with the IR heater 56 and blowing hot air from the hot air blower 58 to the sheet of paper P.

As shown in FIG. 12L, the drying unit 50L may comprise the IR heater 56 inside the driving roller 52 and the driven roller 53, in addition to the heating belt 51, and may comprise the IR heater 56 and the hot air blower 58 disposed inside the rotating drum 26 that receives the sheet of paper P from the drawing drum 42. In this case, the drying unit 50L can heat and dry the sheet of paper P adsorptively transported to the rotating drum 26 with the IR heater, heat the sheet of paper P by blowing hot air from the hot air blower 58 to the sheet of paper P, and heat and dry the sheet of paper P transported on the heating belt 51.

### Modification Example of Pretreatment Liquid Drying Unit 35

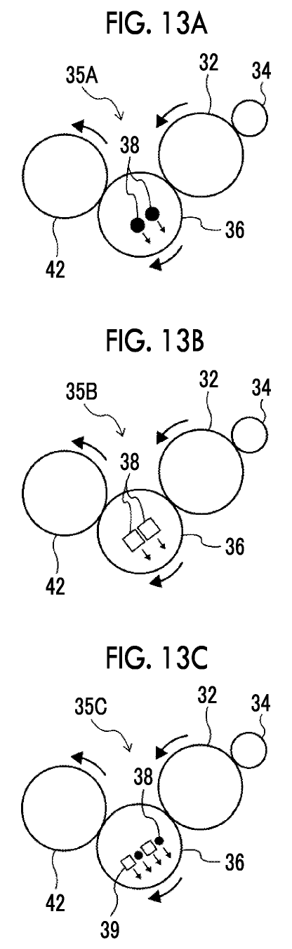

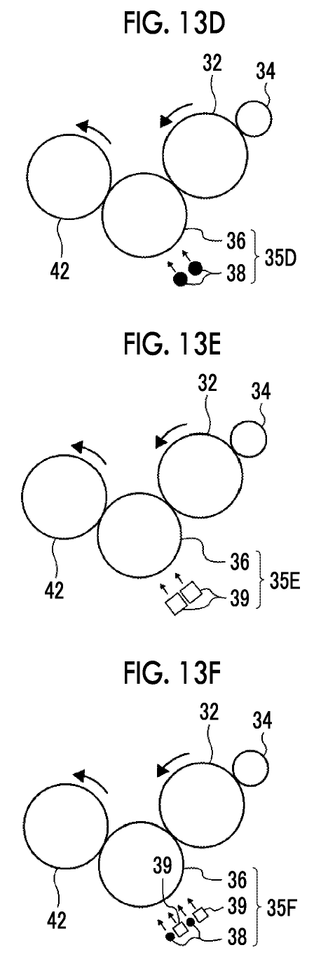

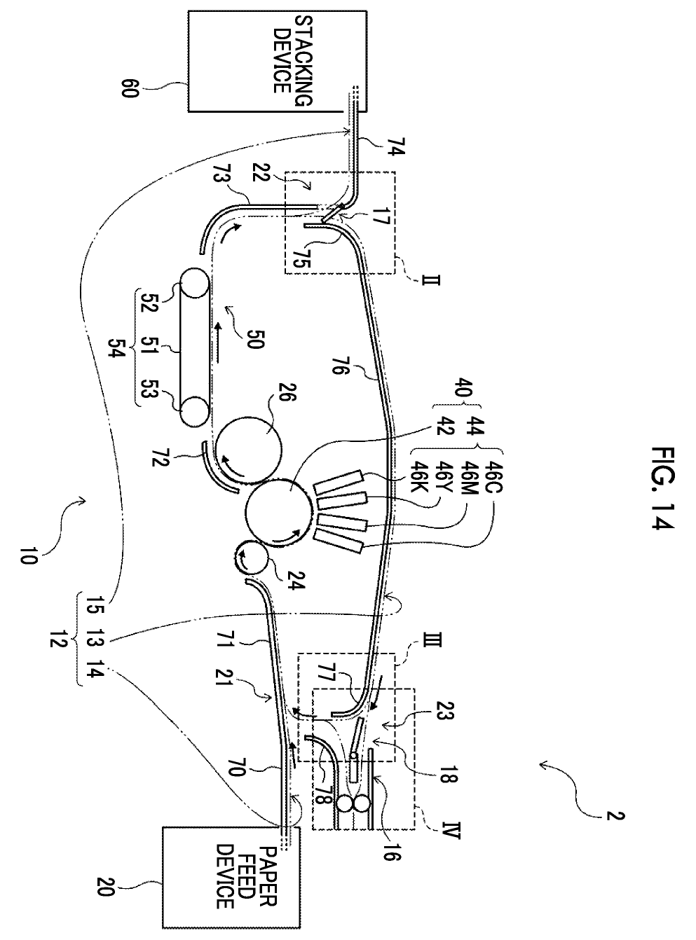

In the above-described embodiment, the form has been described in which the pretreatment liquid drying unit 35 comprises the pretreatment liquid drying drum 36 and heats and dries the sheet of paper P with the pretreatment liquid drying drum 36, but the configuration of the pretreatment liquid drying unit 35 is not limited thereto. The pretreatment liquid drying unit 35 may have any configuration as long as the pretreatment liquid drying unit 35 has an effect of drying the pretreatment liquid. FIGS. 13A to 13F show pretreatment liquid drying units 35A to 35F of modification examples.

The pretreatment liquid drying unit 35A shown in FIG. 13A comprises an IR heater 38 inside the pretreatment liquid drying drum 36. The pretreatment liquid applied to the sheet of paper P transported on the pretreatment liquid drying drum 36 is dried by the sheet of paper P being heated on the heated peripheral surface of the pretreatment liquid drying drum 36 and being heated with the IR heater 38.

The pretreatment liquid drying unit 35B shown in FIG. 13B comprises a hot air blower 39 inside the pretreatment liquid drying drum 36. The pretreatment liquid applied to the sheet of paper P transported on the pretreatment liquid drying drum 36 is dried by the sheet of paper P being heated on the heated peripheral surface of the pretreatment liquid drying drum 36 and being heated with hot air blown from the hot air blower 39.

The pretreatment liquid drying unit 35C shown in FIG. 13C comprises the IR heater 38 and the hot air blower 39 inside the pretreatment liquid drying drum 36. The pretreatment liquid applied to the sheet of paper P transported on the pretreatment liquid drying drum 36 is dried by the sheet of paper P being heated on the heated peripheral surface of the pretreatment liquid drying drum 36, being heated with the IR heater 38, and being heated with hot air blown from the hot air blower 39.

The pretreatment liquid drying unit 35D shown in FIG. 13D comprises the IR heater 38 disposed to face the pretreatment liquid drying drum 36. The pretreatment liquid applied to the sheet of paper P transported on the pretreatment liquid drying drum 36 is dried by the sheet of paper P being heated on the heated peripheral surface of the pretreatment liquid drying drum 36 and being heated with the IR heater 38.

The pretreatment liquid drying unit 35E shown in FIG. 13E comprises the hot air blower 39 disposed to face the pretreatment liquid drying drum 36. The pretreatment liquid applied to the sheet of paper P transported on the pretreatment liquid drying drum 36 is dried by the sheet of paper P being heated on the heated peripheral surface of the pretreatment liquid drying drum 36 and being heated with hot air blown from the hot air blower 39.

The pretreatment liquid drying unit 35F shown in FIG. 13F comprises the IR heater 38 and the hot air blower 39 disposed to face the pretreatment liquid drying drum 36. The pretreatment liquid applied to the sheet of paper P transported on the pretreatment liquid drying drum 36 is dried by the sheet of paper P being heated on the heated peripheral surface of the pretreatment liquid drying drum 36, being heated with the IR heater 38, and being heated with hot air blown from the hot air blower 39.

In the pretreatment liquid drying units 35A to 35F, the transport surface of the pretreatment liquid drying drum 36 is made of a material having a high thermal conductivity, but in a case where the IR heater 38 and/or the hot air blower 39 is provided, the transport surface of the pretreatment liquid drying drum 36 may not be made of a material having a high thermal conductivity.

### Other Modification Examples

In the above-described embodiment, the pre-drying is performed by the drying unit 50, but in a case where the pretreatment liquid drying unit 35 is provided as in the above-described embodiment, the pre-drying may be performed by the pretreatment liquid drying unit 35. Alternatively, the pre-drying may be performed by both the pretreatment liquid drying unit 35 and the drying unit 50. A transport passage may be appropriately set depending on whether the pre-drying is performed by the pretreatment liquid drying unit 35 or the drying unit 50.

In addition, in the above-described embodiment, the pretreatment liquid coating step is performed before the image forming step, but the ink jet printing apparatus 1 may be configured to include a mode in which the pretreatment is performed and a mode in which the pretreatment is not performed, and to be switchable between a mode with the pretreatment and a mode without the pretreatment.

Further, the image forming apparatus according to the present disclosure may have a configuration not comprising the pretreatment liquid coating unit 30 and the pretreatment liquid drying unit 35, as in the ink jet printing apparatus 2 of the modification example shown in FIG. 14. In FIG. 14, the same components as those of the ink jet printing apparatus 1 shown in FIG. 1 are denoted by the same reference numerals, and the detailed description thereof will be omitted. The ink jet printing apparatus 2 does not comprise the pretreatment liquid coating unit 30 and the pretreatment liquid drying unit 35, but other configurations are the same as those of the ink jet printing apparatus 1 described above. The printing process is the same as that in the case of the above-described embodiment except that the printing process does not include the pretreatment liquid coating step and the pretreatment liquid drying step.

In the above, the ink jet printing apparatus 1 comprising the image forming unit 40 that forms an image by an ink jet method has been described, but the image forming apparatus according to the present disclosure is not limited to the ink jet printing apparatus. The image forming apparatus according to the present disclosure can also be applied to, for example, a printing apparatus comprising an image forming unit that forms an image by an electrophotographic method or forms an image by transfer printing.

In the above-described embodiment, an example in which the paper P, which is a cut sheet, is used as the recording medium has been described. However, the medium used for recording an image is not limited to the sheet medium, and may also be a continuous form medium such as continuous form paper. In addition, the sheet medium is not limited to cut paper prepared in a predetermined size in advance, and may also be obtained by cutting a continuous form medium into a predetermined size at any time.

The term “recording medium” is a general term for various terms such as paper, recording paper, printing paper, a printing medium, a print medium, a printed medium, an image forming medium, an image-formed medium, an image receiving medium, and a jetted medium. The material and shape of the medium are not particularly limited, and various sheet bodies such as seal paper, a resin sheet, a film, a cloth, and a non-woven fabric can be used regardless of other materials and shapes. Further, the recording medium is not limited to the sheet body and may be a medium having no flexibility, such as a building material.

The configurations described in the above-described embodiment and the matters described in the modification example can be used in combination as appropriate, or some of the matters can be replaced.

In the embodiment of the present disclosure described above, configuration requirements can be changed, added, or deleted as appropriate without departing from the gist of the present disclosure. The present disclosure is not limited to the above-described embodiment, and many modifications can be made by those having ordinary knowledge in the equivalent related field within the technical idea of the present disclosure.

Regarding the embodiment described above, the following additional notes are further disclosed.

<Supplementary Note 1>

An image forming apparatus comprising:

a transport mechanism including a transport passage that transports a recording medium;

an image forming unit that forms an image on the recording medium;

a drying unit that is capable of performing pre-drying of drying the recording medium before the image formation; and

a processor that controls the transport mechanism, the image forming unit, and the drying unit,

in which the processor is configured to switch between a first mode in which the pre-drying is performed and a second mode in which the pre-drying is not performed.

<Supplementary Note 2>

The image forming apparatus according to Supplementary Note 1, in which the drying unit is capable of performing, in addition to the pre-drying, post-drying of drying the image formed on the recording medium after the image is formed in the image forming unit.

<Supplementary Note 3>

The image forming apparatus according to Supplementary Note 2, in which the processor is configured to:

switch a passage for transporting the recording medium by controlling the transport mechanism, and

switch between the first mode and the second mode by switching the passage.

<Supplementary Note 4>

The image forming apparatus according to Supplementary Note 2 or 3, in which image formation is sequentially performed on a plurality of the recording media by continuously supplying the plurality of recording media to the transport passage, and the drying unit performs both the pre-drying and the post-drying on each of the plurality of recording media.

<Supplementary Note 5>

The image forming apparatus according to Supplementary Note 4, in which, among the plurality of recording media continuously passing through a section in which the drying unit is disposed in the transport passage, the drying unit performs the pre-drying on an N-th recording medium and performs the post-drying on an (N+1)-th recording medium.

<Supplementary Note 6>

The image forming apparatus according to any one of Supplementary Notes 2 to 5, further comprising: two printing modes including a single-sided printing mode in which an image is formed on only one surface of the recording medium and a duplex printing mode in which an image is formed on both a first surface and a second surface of the recording medium.

<Supplementary Note 7>

The image forming apparatus according to Supplementary Note 6, in which at least a part of the transport passage is shared in the single-sided printing mode and the duplex printing mode.

<Supplementary Note 8>

The image forming apparatus according to Supplementary Note 2 or 3, in which, in a case where image formation is sequentially performed on a plurality of the recording media by continuously supplying the plurality of recording media to the transport passage in the duplex printing mode, and the drying unit performs both the pre-drying and the post-drying on each of the plurality of recording media, among the plurality of recording media that continuously pass through a section in which the drying unit is disposed in the transport passage, the drying unit performs the pre-drying on an N-th recording medium, performs the post-drying on an image formed on the first surface with respect to an (N+1)-th recording medium that is the recording medium after the image formation on the first surface, and performs the post-drying on an image formed on the second surface with respect to an (N+2)-th recording medium that is the recording medium after the image formation on the second surface.

<Supplementary Note 9>

The image forming apparatus according to any one of Supplementary Notes 2 to 8, in which the transport mechanism includes a circulation passage in which the image forming unit and the drying unit are disposed and on which the recording medium circulates in the transport passage, a supply passage through which the recording medium is supplied to the circulation passage, a discharge passage through which the recording medium is discharged from the circulation passage, and a switchback unit that temporarily pulls out the recording medium from the circulation passage to reverse a direction of travel of the recording medium, the transport mechanism further includes a first passage switching mechanism that switches a passage of the recording medium between a passage toward the discharge passage and a passage advancing on the circulation passage at a connection portion between the circulation passage and the discharge passage, and a second passage switching mechanism that switches the passage of the recording medium between a passage toward the switchback unit and a passage advancing on the circulation passage at a connection portion between the circulation passage and the switchback unit, and the processor is configured to switch the passage of the recording medium by controlling the first passage switching mechanism and the second passage switching mechanism.

<Supplementary Note 10>

The image forming apparatus according to any one of Supplementary Notes 1 to 9,

in which the processor is configured to receive information regarding the recording medium; and switch between the first mode and the second mode based on the information.

<Supplementary Note 11>

The image forming apparatus according to Supplementary Note 10,

in which the information regarding the recording medium includes a moisture content of the recording medium, and

the processor is configured to:

select the first mode in a case where the recording medium is a recording medium having a moisture content exceeding a preset specified moisture content; and

select the second mode in a case where the recording medium is a recording medium having a moisture content equal to or less than the specified moisture content.

<Supplementary Note 12>

The image forming apparatus according to Supplementary Note 11,

in which the specified moisture content is 4.8%.

<Supplementary Note 13>

The image forming apparatus according to Supplementary Note 10,

in which the information regarding the recording medium includes a thickness of the recording medium, and

the processor is configured to:

select the first mode in a case where the recording medium is a recording medium having a thickness exceeding a preset specified thickness; and

select the second mode in a case where the recording medium is a recording medium having a thickness less than the specified thickness.

<Supplementary Note 14>

The image forming apparatus according to any one of Supplementary Notes 10 to 13,

in which the drying unit is capable of performing, in addition to the pre-drying, post-drying of drying the image formed on the recording medium after the image is formed in the image forming unit, and

the processor is configured to control the drying unit based on the information regarding the recording medium to control a drying output in a case of performing the post-drying.

<Supplementary Note 15>

The image forming apparatus according to Supplementary Note 14,

in which the processor is configured to control the drying output under a condition that an organic solvent amount on the recording medium is 160 μg/cm² or less.

<Supplementary Note 16>

The image forming apparatus according to any one of Supplementary Notes 1 to 15,

in which the pre-drying is a drying step performed before a treatment on the recording medium including application of a pretreatment liquid.

<Supplementary Note 17>

The image forming apparatus according to Supplementary Note 16, further comprising:

a pretreatment liquid coating unit that applies the pretreatment liquid to an image forming surface of the recording medium before forming the image by the image forming unit; and

a pretreatment liquid drying unit that dries the image forming surface to which the pretreatment liquid is applied.

<Supplementary Note 18>

The image forming apparatus according to any one of Supplementary Notes 1 to 17,

in which the image forming unit is a unit that forms an image by an ink jet method.

<Supplementary Note 19>

The image forming apparatus according to any one of Supplementary Notes 1 to 18,

in which the recording medium is paper.

The disclosure of JP2023-197533 filed on November 21, 2023 is incorporated herein by reference in its entirety.

All documents, patent applications, and technical standards described in the present specification are herein incorporated by reference to the same extent that each individual document, patent application, or technical standard was specifically and individually indicated to be incorporated by reference.

What is claimed is:

1. An image forming apparatus comprising:
a transport mechanism including a transport passage that transports a recording medium;
an image forming unit is configured to form an image on the recording medium;
a drying unit is configured to be capable of performing pre-drying of drying the recording medium before image formation; and
a processor that controls the transport mechanism, the image forming unit, and the drying unit,
wherein the processor is configured to switch between a first mode in which the pre-drying is performed and a second mode in which the pre-drying is not performed.

2. The image forming apparatus according to claim 1,
wherein the drying unit is configured to be capable of performing, in addition to the pre-drying, post-drying of drying the image formed on the recording medium after the image is formed in the image forming unit.

3. The image forming apparatus according to claim 2,
wherein the processor is configured to:
switch a passage for transporting the recording medium by controlling the transport mechanism, and
switch between the first mode and the second mode by switching the passage.

4. The image forming apparatus according to claim 2,
wherein the image forming apparatus is configured to sequentially perform image formation on a plurality of the recording media by continuously supplying the plurality of recording media to the transport passage, and the drying unit is configured to perform both the pre-drying and the post-drying on each of the plurality of recording media.

5. The image forming apparatus according to claim 4,
wherein, the image forming apparatus is configured to such that, among the plurality of recording media continuously passing through a section in which the drying unit is disposed in the transport passage, the drying unit is configured to perform the pre-drying on an N-th recording medium and performs the post-drying on an (N+1)-th recording medium.

6. The image forming apparatus according to claim 2,
wherein, the image forming apparatus two printing modes including a single-sided printing mode in which an image is formed on only one surface of the recording medium and a duplex printing mode in which an image is formed on both a first surface and a second surface of the recording medium.

7. The image forming apparatus according to claim 6,
wherein at least a part of the transport passage is shared in the single-sided printing mode and the duplex printing mode.

8. The image forming apparatus according to claim 7,
wherein, the processor is configured to perform control such that, in a case where image formation is sequentially performed on a plurality of the recording media by continuously supplying the plurality of recording media to the transport passage in the duplex printing mode, and the drying unit performs both the pre-drying and the post-drying on each of the plurality of recording media,
among the plurality of recording media that continuously pass through a section in which the drying unit is disposed in the transport passage, the drying unit performs the pre-drying on an N-th recording medium, performs the post-drying on an image formed on the first surface with respect to an (N+1)-th recording medium that is the recording medium after the image formation on the first surface, and performs the post-drying on an image formed on the second surface with respect to an (N+2)-th recording medium that is the recording medium after the image formation on the second surface.

9. The image forming apparatus according to claim 3,
wherein the transport mechanism includes a circulation passage in which the image forming unit and the drying unit are disposed and on which the recording medium circulates in the transport passage, a supply passage through which the recording medium is supplied to the circulation passage, a discharge passage through which the recording medium is discharged from the circulation passage, and a switchback unit that temporarily pulls out the recording medium from the circulation passage to reverse a direction of travel of the recording medium,
the transport mechanism further includes a first passage switching mechanism that switches a passage of the recording medium between a passage toward the discharge passage and a passage advancing on the circulation passage at a connection portion between the circulation passage and the discharge passage, and
a second passage switching mechanism that switches the passage of the recording medium between a passage toward the switchback unit and a passage advancing on the circulation passage at a connection portion between the circulation passage and the switchback unit, and
the processor is configured to switch the passage of the recording medium by controlling the first passage switching mechanism and the second passage switching mechanism.

10. The image forming apparatus according to claim 1,
wherein the processor is configured to receive information regarding the recording medium; and switch between the first mode and the second mode based on the information.

11. The image forming apparatus according to claim 10,
wherein the information regarding the recording medium includes a moisture content of the recording medium, and
the processor is configured to:
select the first mode in a case where the recording medium is a recording medium having a moisture content exceeding a preset specified moisture content; and
select the second mode in a case where the recording medium is a recording medium having a moisture content equal to or less than the specified moisture content.

12. The image forming apparatus according to claim 11,
wherein the specified moisture content is 4.8%.

13. The image forming apparatus according to claim 10,
wherein the information regarding the recording medium includes a thickness of the recording medium, and
the processor is configured to:
select the first mode in a case where the recording medium is a recording medium having a thickness exceeding a preset specified thickness; and
select the second mode in a case where the recording medium is a recording medium having a thickness less than the specified thickness.

14. The image forming apparatus according to claim 10,
wherein the drying unit is configured to be capable of performing, in addition to the pre-drying, post-drying of drying the image formed on the recording medium after the image is formed in the image forming unit, and
the processor is configured to control the drying unit based on the information regarding the recording medium to control a drying output in a case of performing the post-drying.

15. The image forming apparatus according to claim 14,
wherein the processor is configured to control the drying output under a condition that an organic solvent amount on the recording medium is 160 μg/cm² or less.

16. The image forming apparatus according to claim 1,
wherein the pre-drying is a drying step performed before a treatment on the recording medium including application of a pretreatment liquid.

17. The image forming apparatus according to claim 16, further comprising:
a pretreatment liquid coating unit is configured to apply, before the image formation by the image forming unit, the pretreatment liquid to an image forming surface of the recording medium before the image is formed; and
a pretreatment liquid drying unit that dries the image forming surface to which the pretreatment liquid is applied.

18. The image forming apparatus according to claim 1,
wherein the image forming unit is a unit that forms an image by an ink jet method.

19. The image forming apparatus according to claim 1,
wherein the recording medium is paper.
